(19) United States
(12) Patent Application Publication
(10) Pub. No.: US 2026/0292115 A1
(43) Pub. Date: Sep. 24, 2026

(54) Methods and Apparatus for Using Illumination Images Having Different Frequency Content and/or Resolutions To Facilitate Stereoscopic Depth Determinations

(71) Applicant: More, Inc., San Mateo, CA (US)

(72) Inventors: Rajiv Laroia, Far Hills, NJ (US); Divya Gupta, Redwood City, CA (US)

(21) Appl. No.: 19/086,123

(22) Filed: Mar. 20, 2025

Related U.S. Application Data
(60) Provisional application No. 63/774,099, filed on Mar. 18, 2025.

(51) Int. Cl. H04N 13/271; H04N 13/00; H04N 13/363

(52) U.S. Cl. CPC H04N 13/271; H04N 13/363; H04N 2013/0081

(57) ABSTRACT

Methods and apparatus for generating and using images, e.g. bandlimited images, for use as illumination patterns to support stereoscopic depth determinations are described. In various embodiments bandwidth limited images having different frequency content and/or resolutions are generated using low pass filtering to limit the frequency content of the images. An illumination image is selected, e.g., dynamically, based on a camera to object surface distance and/or a projector to object surface distance taking into consideration the sampling ability of the cameras being used so that the selected illumination image projected onto a surface will be captured without aliasing effects and/or so that it will be of a resolution which facilitates stereoscopic depth determinations, e.g., higher resolution illumination images are selected over lower resolution illumination images when the frequency content of the selected image is within the capture capabilities of the cameras being used to capture the projected pattern without aliasing.

### RELATED APPLICATIONS

The present application claims the benefit of U.S. Provisional Patent Application Ser. No. 63/774,099 filed Mar. 18, 2025 which is hereby expressly incorporated by reference in its entirety.

### BACKGROUND

For purposes of depth determination, in some systems a displayed image pattern is captured using cameras which are offset from one another by a known distance. The images captured by different cameras are compared to identifying matching portions and the distance between the location of the matchings portions from one another in terms of the location within the captured images is used to determine the distance to the object, e.g., from a camera which is used as a reference camera.

The term resolution is often used to refer to the level of detail in an image. For an image of a given size, a high resolution image will have more detail in it than a low resolution image. For stereoscopic depth determinations the resolution of an image being observed can affect the accuracy of the depth determination. Highly detailed images which can be accurately observed can be used to provide detailed depth estimates while lower resolution images which are observed can result in less accurate depth determinations given the lower resolution of the image being observed. While the resolution of a displayed image being used for depth determination purposes can affect the accuracy and/or level of detail to which a depth determination can be made based on capture and processing of the displayed image by a stereoscopic camera pair, the ability of cameras in the stereoscopic camera pair to accurately capture the displayed image, e.g., using a lens and digital image sensor, can also affect stereoscopic depth determinations.

For accurate matching between portions of images captured by different cameras in the stereoscopic system, it is desirable to avoid unintentional distortions in the captured images which can result in erroneous matches between portions of images captured by different cameras and thus errors in stereoscopic depth determinations.

Distortions and/or errors in images captured by digital sensors of cameras can be due to a variety of sources including sampling related issues. In a digital camera each sample, e.g., value representing an amount of light captured by a sensor element corresponding to a pixel, captured by a camera sensor is normally represented as a value, e.g., pixel value. The camera sensor effectively samples a displayed or projected image to create a digital representation of the image in the form of a set of pixel values. The resolution of the sensor and/or various other factors including the camera lens or lenses being used and the distance from a camera to a surface on which a displayed image is observed determines the area of the image which corresponds to a pixel element of the camera. The farther away the camera is from the object surface on which a projected image is displayed, the greater the area corresponding to an individual pixel sensor. Thus, in many cases, the farther away the surface on which an image being observed from the cameras of a stereoscopic pair, the lower the resolution the cameras will be able to accurately detect and resolve, e.g., between different objects or portions of an observed image pattern.

The phrase spatial resolution in terms is often used to refer to the ability to differentiate two objects and is based not only on the number of pixels of an image sensor but also other optical/lens considerations. Cameras and depth determination systems with low spatial resolution will be unable to distinguish between objects spaced closely together, while cameras and depth determination systems with higher spatial resolution will be able to distinguish between objects and distances which are spatially close to each other. For practical purposes the clarity of the image is decided by its spatial resolution, which can be lower than a camera sensor's resolution, which normally corresponds to the number of pixel elements (sensor elements) in a camera sensor. In effect, spatial resolution can be thought of as the number of independent pixel values per unit length which can be detected by a camera or other system.

In signal processing, aliasing is the overlapping of frequency components resulting from a sample rate below the Nyquist rate, which is required for accurate reproduction of an analog signal without the loss of information due to digital sampling. A displayed image is, in effect, an analog signal which is sampled by a camera that includes a lens and sensor. Aliasing can result when the detail/resolution of a displayed image pattern exceeds a camera's ability to sample the image at a sufficiently high rate.

Aliasing results in distortion or artifacts when the signal, e.g., original image, is reconstructed from samples which causes the reconstructed signal/image to differ from the original continuous signal. Aliasing in spatially sampled images, e.g., digital images captured by digital cameras, are sometimes referred to as, moiré patterns, are a form of spatial aliasing.

For cost and/or other practical physical reasons, the sampling rate and thus Nyquist rate of cameras used for stereoscopic depth determinations are limited by the physical limitations of the camera systems used to capture images used for stereoscopic depth determinations.

Given the sampling limitations of camera systems used for stereoscopic depth determination purposes, it would be desirable if methods and/or apparatus could be developed which could facilitate depth determinations based on projected images with one or more components of the system taking into consideration camera sampling limitations, distance between a projector used to illuminate a surface or object with a light pattern and/or the distance between a camera used to capture an image of a displayed pattern.

### SUMMARY OF THE INVENTION

In stereoscopic systems, cameras in the system are normally of a known type and lens configuration with the cameras of a stereoscopic pair often having the same type of sensors and thus sensor resolution in addition to having the same lens configuration. Accordingly, in such a system the sampling rate, e.g., rate at which image samples are collected over an observed image area, are known given the camera sensor and lens arrangement being used and the Nyquist rate of the image camera system is known. Thus, the spatial resolution of the cameras, including lens assemblies, used to capture images for stereoscopic depth determinations is known and predictable for a given camera arrangement being used.

For purposes of stereoscopic depth determinations, in various embodiments a scene area is illuminated by an image including an image pattern, e.g. a random or pseudo random image pattern. Depending on the embodiment the pattern can be of black and white pixels, a pattern of grayscale pixels or color pixels.

In determining the image pattern to project for illumination purposes, the sampling capabilities of the cameras are taken into consideration, and, in some but not necessarily all embodiments, one or more distances are also considered, in determining the image pattern and/or resolution of the image pattern to be displayed. In embodiments where one or more distances are taken into consideration, a distance from the projector used to project an illumination pattern to a surface being illuminated and/or the distance from the illuminated surface to a camera in the camera capture system are taken into consideration.

The pattern which is displayed for illumination purposes is one which can accurately be sampled by the camera system without suffering from aliasing as a result of the limited sampling rate supported by the cameras being used to capture the images used for stereoscopic depth determination purposes. In this way, illumination patterns with high frequency content that can not be accurately sampled by the camera system being used are intentionally avoided. This often involves limiting the resolution of the displayed image pattern to a resolution which allows the cameras of the stereoscopic system to accurately sample and accurately represent the displayed image pattern as a set of pixel values.

In some embodiments the illumination system supports a plurality of image patterns and/or image pattern resolutions that can be displayed. An image pattern is displayed and captured by the stereoscopic depth determination system. The stereoscopic depth determination system determines the depth to the surface on which the illumination pattern is displayed. Based on the distance between the camera(s) used to capture the image pattern and the surface on which the pattern is displayed, an updated determination of the pattern and/or resolution of the image pattern to be displayed is made.

In selecting an updated pattern to be used, in some embodiments, a determination is made if a higher resolution pattern supported by the illumination system can be projected and thus displayed onto the surface/objects being observed without the pattern exceeding the ability of the camera system to accurately capture the image, e.g., without suffering from aliasing. If an image pattern and/or higher resolution version of an image pattern can be used without causing aliasing problems, the system switches to using the new pattern and/or resolution. If in determining the image pattern/resolution to be used it is determined that the image pattern and/or resolution in use is subject to aliasing, a switch is made to display a different image pattern or a lower resolution version of the image pattern so that the captured image is not subject to aliasing.

In some embodiments the position of the illumination device relative to the cameras being used to capture images of the area/surface being illuminated are known. In least some such embodiments the distance from the illumination/display device, e.g., light projector, used to illuminate a surface with the selected illumination pattern is known and/or can be determined from the determined distance between the camera(s) and the illuminated surface/objections. In other embodiments the distance between the illumination device projecting the image pattern and illuminated surface/objects is known or determined in other ways. In embodiments where the distance between the illumination device and illuminated surface/objects is known, this distance is also taken into consideration when determining the illumination pattern and/or resolution of the illumination pattern to be used.

In various embodiments images with different frequency content and/or resolution are generated and stored. This is done by generating images of different resolutions and/or filtering an image using one or more bandpass filters with different frequency cutoffs to generate images with different frequency content. In some embodiments the bandpass filters are low pass filters with different upper frequency cutoffs. As a result of the bandpass filtering, used in some embodiments, multiple images are created and stored, with some of the images having content limited, by the bandpass filtering, to lower frequencies than other images. For example, in one embodiment a first lowpass filter with an upper cutoff frequency of F3 is used, a second lowpass filter with an upper cutoff frequency of F2 is used, and a third low pass filter with an upper cutoff of F1 is used, where F3 is a higher frequency than F2 or F1, and F2 is a higher cutoff frequency than F1. This filtering will result in 3 different bandlimited images being generated from an initial image/pattern each corresponding to a different frequency range. The image created by using the lowpass filter with the F3 cutoff will include the largest frequency band and will include the highest frequencies. The image created by using the lowpass filter with the F2 cutoff will include a medium size frequency band and will include the second highest frequencies while the image created by using the lowpass filter with the F1 cutoff will correspond to the smallest and lowest frequency band of the 3 images generated by filtering an initial image. A selection of which of the bandlimited images generated by the filtering can be, and sometimes is, based on the CTOSD and/or PTOSD associated with image capture/depth determination at a given point in time. The device 104 can switch between which bandlimited image is used for depth determination, as one or more of the distances relevant to the depth determination operation changes in a way that avoids, minimizes or limits the amount of aliasing/image distortion that will be encountered with regard to images captured for depth determination purposes.

The images to be used for illumination purposes to facilitate depth detection are selected based on one or more factors including the sampling capabilities of the cameras being used and/or the distance to one or more objects to be illuminated. In this way aliasing can be avoided and/or minimized.

In some embodiments a bandlimited illumination pattern can be, and sometimes is, selected for illumination purposes from a plurality of bandlimited illumination patterns. The selected pattern, e.g., image, when projected onto an object surface, will have a maximum frequency (Fm) content which can be accurately captured by the cameras being used since the pattern is selected based on the known frequency band to which the image content corresponds.

In some embodiments, the illumination image used at a given time is selected, e.g., based on a projector to object surface distance (PTOSD) and/or camera to object surface distance (CTOSD) so as to take into consideration the Nyquist rate of the cameras in the stereoscopic camera array, used to capture images for stereoscopic depth determination purposes, e.g., given the depth (sometimes referred to as distance) from the cameras to a surface of the object on which the illumination image is projected.

The Nyquist Rate, fn, is equal to 2fm, (i.e., fn=2fm), where fm is the maximum frequency component that is present in a signal (e.g., observed image on a surface). If the signal, e.g., illumination pattern visible on the surface of an object due to projection of the illumination image, is sampled at a rate greater than Nyquist rate (fn), then the signal is known as oversampled and will be accurately captured. If the signal is sampled at a rate less than Nyquist rate (fn), then the signal is known as under-sampled and will include errors due to the low sampling rate, i.e., aliasing errors. Given the Nyquist rate (fn) for cameras being used, an illumination image is selected which will be oversampled when captured by the cameras so that aliasing errors are avoided. The bandwidth limited illumination image, in some embodiments, is selected so that oversampling occurs but is preferably minimized, e.g., to a desired range, so that an image with a good amount of resolution is used to facilitate stereoscopic depth determination while avoiding use of an extremely low resolution illumination image, which can make depth determination difficult to achieve with a high level of accuracy.

By dynamically selecting the illumination pattern to be used based on the distance between the camera(s) and illuminated surface/objects which are illuminated and/or the sampling capabilities of the cameras being used in the stereoscopic camera system at a given time, and the frequency content of the available illumination patterns, an image, having a relatively high resolution can be selected and used for illumination purposes while still avoiding aliasing.

As the distance to an illuminated object or scene changes, a different illumination image pattern can, and sometimes will, be selected with the resolution and/or frequency content of the selected image, used for illumination purposes, being changed as necessary to avoid aliasing but also to maintain a high resolution, as a result of the illumination image selection process to avoid or reduce possible aliasing effects that might interference with stereoscopic depth determinations based on captured images of the projected illumination pattern.

The methods of the present invention are applicable to visible as well as non-visible images projected for illumination purposes, and, in many embodiments, involve the use of color or grayscale images projected using visible light to facilitate stereoscopic image capture related operations and stereoscopic depth determinations.

Numerous variations on the above described methods and apparatus will be discussed in the detailed description which follows.

### BRIEF DESCRIPTION OF THE DRAWINGS

FIG. 1 illustrates an exemplary system including an illumination device and stereoscopic camera system implemented in accordance with one embodiment of the present invention which is capable of projecting illumination pattern images, e.g., band limited images, capturing images and making stereoscopic depth determinations in accordance with the present invention.

FIG. 2 shows the robotic device shown in FIG. 1 in greater detail.

FIG. 3 is a block diagram showing the robotic device of FIGS. 1 and 2 and components included therein in greater detail.

FIG. 4 shows the relationship between a light projector, illuminated surface and cameras, along with various distances which can help in understanding various aspect of the invention relating to illumination pattern frequency band limiting and/or selection of image patterns having different resolutions based on one or more distances such as the distance between the light projector used to display an illumination pattern and an illuminated surface and/or the distance between the camera(s) used to capture images of the illuminated surface and the illuminated surface.

FIG. 5 shows exemplary illumination patterns of different resolutions, and having different maximum frequency content, e.g., different maximum frequencies, due to the different illumination pattern content, which may be selected and used at different times, e.g., based on the illumination projector to object surface distance (PTOSD) and/or camera to object surface distance (CTOSD) being encountered at a given time.

FIG. 6 shows that the size of the projected image on the illuminated surface will depend on the distance between the illumination projector and illuminated surface, given the optics of the illumination device which tend to enlarge a projected image with the size of the displayed image being larger the farther the illuminated surface is away from the illumination projector.

FIG. 7A is a first part of a flow chart showing steps involved in generating, selecting and displaying illumination patterns, e.g., band limited illumination patterns, in accordance with the invention.

FIG. 7B is a second part of a flow chart showing steps involved in generating, selecting and displaying illumination patterns, e.g., band limited illumination patterns, in accordance with the invention.

FIG. 7C is a third part of a flow chart showing steps involved in generating, selecting and displaying illumination patterns, e.g., band limited illumination patterns, in accordance with the invention.

FIG. 7 shows how FIGS. 7A, 7B, 7C can be combined into a complete flow chart showing steps involved in generating, selecting and displaying illumination patterns, e.g., band limited illumination patterns, in accordance with the invention.

FIG. 8 shows an unfiltered exemplary low resolution illumination pattern, e.g., a black and white illumination pattern.

FIG. 9 shows a first low resolution filtered illumination pattern, e.g., a grayscale image pattern, generated by filtering the illumination pattern of FIG. 8, using a bandpass filter, which limits the maximum frequency of the image, generated by filtering the image shown in FIG. 8, to reduce the upper frequency content of the image, based on an upper cutoff frequency, F3, of the bandpass filter, used to filter the image of FIG. 8.

FIG. 10 shows a second low resolution filtered illumination pattern, e.g., a grayscale image pattern, generated by filtering the illumination pattern of FIG. 8, using a bandpass filter, which limits the maximum frequency of the image, generated by filtering the image shown in FIG. 8, to reduce the upper frequency content of the image, based on an upper cutoff frequency, F2, of the bandpass filter, used to filter the image of FIG. 8, where F2<F3.

FIG. 11 shows a third low resolution filtered illumination pattern, e.g., a grayscale image pattern, generated by filtering the illumination pattern of FIG. 8, using a bandpass filter, which limits the maximum frequency of the image, generated by filtering the image shown in FIG. 8, to reduce the upper frequency content of the image, based on an upper cutoff frequency, F1, of the bandpass filter, used to filter the image of FIG. 8, where F1<F2<F3.

FIG. 12 shows an unfiltered exemplary medium resolution illumination pattern, e.g., a black and white illumination pattern

FIG. 13 shows a first medium resolution filtered illumination pattern, e.g., a grayscale image pattern, generated by filtering the illumination pattern of FIG. 12, using a bandpass filter, which limits the maximum frequency of the image, generated by filtering the image shown in FIG. 9, to reduce the upper frequency content of the image, based on an upper cutoff frequency, F6, of the bandpass filter, used to filter the image of FIG. 12.

FIG. 14 shows a second medium resolution filtered illumination pattern, e.g., a grayscale image pattern, generated by filtering the illumination pattern of FIG. 12, using a bandpass filter, which limits the maximum frequency of the image, generated by filtering the image shown in FIG. 12, to reduce the upper frequency content of the image, based on an upper cutoff frequency, F5, of the bandpass filter, used to filter the image of FIG. 12, where F5<F6.

FIG. 15 shows a third medium resolution filtered illumination pattern, e.g., a grayscale image pattern, generated by filtering the illumination pattern of FIG. 12, using a bandpass filter, which limits the maximum frequency of the image, generated by filtering the image shown in FIG. 12, to reduce the upper frequency content of the image, based on an upper cutoff frequency, F4, of the bandpass filter, used to filter the image of FIG. 12, where F4<F5<F6.

FIG. 16 shows an unfiltered exemplary high resolution illumination pattern, e.g., a black and white illumination pattern.

FIG. 17 shows a first high resolution filtered illumination pattern, e.g., a grayscale image pattern, generated by filtering the illumination pattern of FIG. 16, using a bandpass filter, which limits the maximum frequency of the image, generated by filtering the image shown in FIG. 16, to reduce the upper frequency content of the image, based on an upper cutoff frequency, F9, of the bandpass filter, used to filter the image of FIG. 16.

FIG. 18 shows a second high resolution filtered illumination pattern, e.g., a grayscale image pattern, generated by filtering the illumination pattern of FIG. 16, using a bandpass filter, which limits the maximum frequency of the image, generated by filtering the image shown in FIG. 16, to reduce the upper frequency content of the image, based on an upper cutoff frequency, F8, of the bandpass filter, used to filter the image of FIG. 16, where F8<F9.

FIG. 19 shows a third low resolution filtered illumination pattern, e.g., a grayscale image pattern, generated by filtering the illumination pattern of FIG. 16, using a bandpass filter, which limits the maximum frequency of the image, generated by filtering the image shown in FIG. 16, to reduce the upper frequency content of the image, based on an upper cutoff frequency, F7, of the bandpass filter, used to filter the image of FIG. 16 where F7<F8<F9.

### DETAILED DESCRIPTION

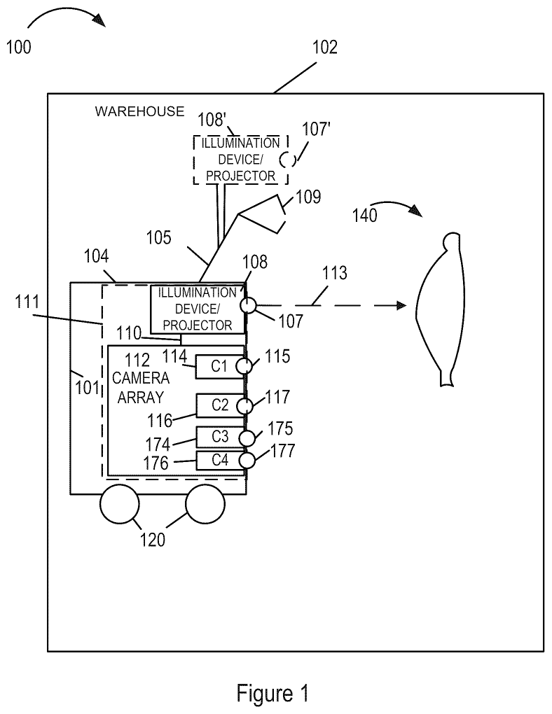

FIG. 1 is a diagram 100 illustrating an exemplary system, e.g., device 104, shown at a warehouse 102. Device 104, in the example, is a robotic device. The robotic device 104 can be in the form of a wheeled robot or other device. Depending on the embodiment, the device 104 may be at a fixed location, e.g., having a known distance 113 to an object 140 to be measured, or may move and change its position relative to the object to be measured over time. In the FIG. 1 example, the robotic device 104 includes a device main body 101, represented by the box, to which reference number 101 makes contact. The device 104 is on wheels 120 and includes an arm 105, with an object manipulator or claw 109 attached thereto. The claw 109 can be, and sometimes is, used to manipulate the position of objects within reach of the claw 109.

To facilitate control of the device 104 and/or to allow the device 104 to be used as an observation/depth measurement platform, the device 104 includes an illumination device 108, e.g., a digital or analog light projector, which can project through lens 107 an image used to illuminate the object 140 to be measured/observed. The light projector 108 can be an IR light projector, but, in many embodiments, is a visible light projector capable of projecting monochrome and/or color images, with, as will be discussed below, the image selected and used for illumination purposes being, in many cases, a resolution or frequency bandwidth limited image, displaying a pattern, e.g., a random or pseudo random pattern, in some embodiments, intended to facilitate stereoscopic depth determinations based on comparisons of images captured by different cameras.

To facilitate stereoscopic depth determination, the device 104 includes a camera array 112 which is coupled to the illumination device 108 by control line 110 which allows for the synchronization of the projection of an illumination pattern with image capture performed by the cameras of the camera array 112. In the illustrated embodiment the camera array 112 includes a first pair of cameras (C1 114, C2 116) and a second pair of cameras (C3 174, C4 176), with the cameras being spaced apart from one another by a fixed distance, which is known and can be used to facilitate stereoscopic depth determinations, where the distance to different portions of the object 140 can be determined, e.g., with respect to a reference camera of a camera pair or reference point. The reference camera can any one of the cameras in a camera pair used for stereoscopic depth determination purposes, e.g., camera C1 114, camera C2 116, camera C3 174 or camera C4 176. The cameras of a stereoscopic camera pair are normally of the same design and thus normally have the same frequency capture capabilities, which can be a function of the type and/or shape of camera lens being used. Camera C1 114 includes lens 115, while camera C3 116 includes lens 117. Lenses 115 and 117 will normally be of the same type and shape, since they correspond to cameras C1 114, C2 116 of the first stereoscopic camera pair. Camera C3 174 includes lens 175, while camera C4 176 includes lens 177. Lenses 175 and 177 will normally be of the same type and shape, since they correspond to cameras of the second stereoscopic camera pair 174, 176 and can be the same or different from lenses 115, 117.

Because of the use of different lenses and/sensors, different camera pairs may have different frequency capture capabilities. In some embodiments different camera pairs are used at different times for stereoscopic depth determination, in which case the illumination pattern selected to be used at a given time will be based on the frequency range that can be captured by the camera pair 114, 116 or 174, 176 in use at a given time. The frequency capture capabilities of the camera pairs (C1 114, C2 116), (C3 174, C4 176) are known from the physical characteristics of the cameras and are stored and used in determining what illumination pattern to select for illumination purposes at a given time, e.g., with the distance 113 to the object 140 being taken into consideration when selecting the illumination image, e.g., pattern, to use.

While in some embodiments the illumination device 108 is mounted in or on the main body 101 of the device 104, in other embodiments the illumination device is mounted on the arm 105 or another movable part of the device 104, as represented by illumination device 108′ and lens 107′ shown using dashed lines. In such a case as the arm 105 moves, the illumination device 108′ will also move, ensuring that an object, to be picked up by the arm 105, will remain in the area illuminated by device 108′, which projects an image onto the object 140, to be measured. In such a case, the projector to object surface distance (PTOSD), between the illumination device 108′ and the illuminated object 140, may change, while the distance between the camera array pair C1 114, C2 116 or C3 174, C4 176 will remain constant, assuming the device 104 is not moving. In other embodiments, the camera array pair C1 114, C2 116 or C3 174, C4 176 is mounted on the arm 105 or another movable portion of the device 104 and can change position/distance 113 to the object 140 while the camera to object surface distance (CTOSD) remains fixed. In still other cases both the PTOSD and/or CTOSD may change by different amounts as the arm and/or device 104 moves. The PTOSD, CTOSD and/or both distances can be, and sometimes are, taken into consideration when selecting an image/pattern to project as an illumination image to support stereoscopic depth determination. By taking into consideration such distances and/or the capability of the cameras to capture images without aliasing, the resolution and/or frequency content of the illumination image, projected on a surface, can be matched to the capability of the cameras, being used to capture images for stereoscopic depth determination purposes. As a result, an image, with a level of detail and/or frequency content matching or approaching the capability limits of the cameras 114, 116, or 174, 176, being used to capture images, can be projected, while avoiding projecting an image with excessive detail/frequency content that can not be accurately captured by the cameras being used and which could thus introduce aliasing or other errors into the captured images used for depth determination.

In some embodiments the distance 113 to the object 140 is the distance to a nearest part of the object 140, but this distance can be a rough number of inches or feet or meters and, in some embodiments, need not be precise since the distance is being used, in some embodiments, to simply select between a limited number, e.g., 3, 9 or 12, of available illumination images which may be used. Stereoscopic depth determination will be used to determine precise distances to different portions of the object 140 and, once an initial stereoscopic depth determination is made, the result can be, and sometimes is, used to select an illumination image to be used to illuminate an image for a future stereoscopic depth determination. Accordingly for the initial illumination an expected distance to the object is sometimes used to select the illumination image to be used. Then, in some embodiments, the image selected for illumination purposes subsequently is selected based on a distance determined from an initial or preceding stereoscopic depth determination.

While the 3D object 140 is in the shape of a person or statue in the FIG. 1 example, the object to be measured could be any 3D object which is to be measured, modeled and/or examined for manipulation, quality control, collision avoidance and/or a host of other operations including generating a 3D model of the object 140 subject to measurement.

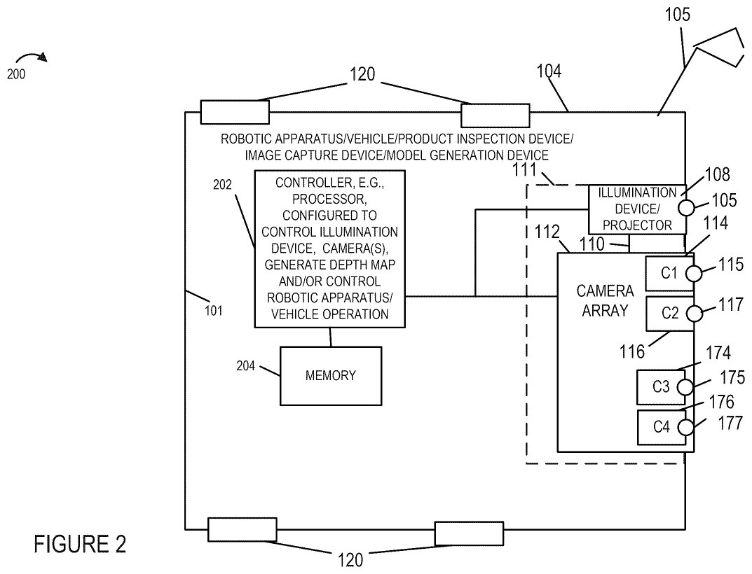

FIG. 2 is a diagram of 200 showing components included in the robotic device 104 of FIG. 1 in greater detail. As shown in FIG. 2, within the body 101 of the robotic device 104 is a controller 202, e.g., a processor, configured to control the illumination device 108, cameras 114, 116, 174, 176, filter images to generate bandlimited images which can be selected to be displayed, select an illumination image/pattern to be projected by projector 108, generate a depth map from captured images, and/or otherwise control the device 104 to operate in accordance with the invention. In the FIG. 2 embodiment, the processor 202 in the body 101 of the robotic device 104 is coupled to a memory 204 in addition to an illumination device/camera array assembly 111. The processor 202 controls the illumination device 108 to project image(s), e.g., bandlimited images, and to perform the capture of images by the cameras of the camera array 112, so that the captured images can be processed for depth determination purposes. The memory 204 stores the illumination images which can be selected in accordance with the invention for projection by the illumination device 108, as well as the captured images captured by cameras 114, 116, 174, 176 of the camera array 112, as well as depth information. generated from the captured images.

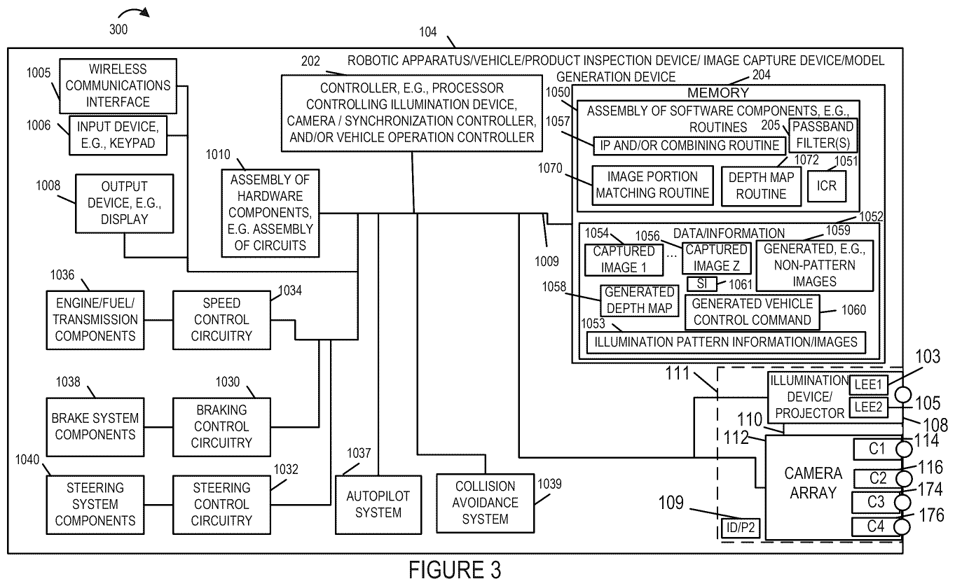

FIG. 3 is a block diagram 300 showing components in the device 104 of FIGS. 1 and 2 and components included therein in greater detail with the arm 105 and some other features not being shown due to space limitations in the figure.

FIG. 3 is another drawing 300 of the exemplary apparatus 104, e.g., robotic device or vehicle, which supports illumination and image capture for depth determination purposes with still more details shown. Exemplary apparatus 104 includes a plurality of cameras, camera 1 (C1) 114, camera 2 (C2) 116, which are part of the camera array 112. The cameras capture images of the scene area illuminated by illumination device 108 in accordance with the invention. Exemplary robotic device or vehicle 104 further includes controller 202, e.g., a processor, configured to control illumination and camera operation including camera synchronization with the output, e.g. displayed images, of the illumination device 108. The controller 202 is configured to identify matching portions of images to produce depth information, generate a depth map, and/or control vehicle operation. Memory 204 stores illumination pattern information 1053, which includes the patterns, e.g., first and second images, to be displayed and the sequence in which the patterns are to be displayed for illumination purposes. A wide variety of patterns, e.g., black and white and/or color pixel patterns can be stored in information 1053 and displayed e.g., by illumination device 108, as part of a video sequence used for illumination purposes. The patterns which are images may be stored in a variety of data formats depending on the embodiment and need not be stored as a bitmap but can be stored as equations or other data used to render the images to be displayed as part of the illumination process.

The first camera C1 114 and second camera C2 116 are mounted on apparatus 104 facing in the direction of the scene area that is illuminated by illumination device/projector 108. Controller 202 is coupled to each of the cameras (C1 114, C2 116, C3 174, C4 176). Controller 202 controls the illumination device 108 to illuminate a scene area, e.g., by sequentially displaying image patterns in accordance with the information stored in illumination pattern information 1053, while cameras C1 114, C2 116 are controlled to capture images of the illuminated scene area.

Controller 202 receives images captured by each of the cameras (C1 114, C2 116) during a frame time, in which a pattern is displayed by illumination device 108. In some embodiments controller 202 identifies matching portions of images corresponding to the same frame time, e.g., captured from different cameras at the same time, and uses the information about which portions match to determine depth to objects in the scene area. Thus, in some embodiments, controller 202 uses matching portions of images to produce depth information and generate a depth map.

In other embodiments controller 202 causes captured images to be communicated, e.g., wirelessly via wireless communications interface 1005, to a cloud or network based image processing system. The cloud or network based image processing system processes the communicated images and returns a depth map to the apparatus 104 to be used for device control.

In some embodiments, controller 202 controls a robotic apparatus/vehicle control operation, e.g., one of a direction, braking, or speed control operation, to be performed in response to a generated depth map. In various embodiments, controller 202 uses the depth map information to perform collision avoidance operations and/or perform autopilot operations.

Exemplary apparatus 104 shown in FIG. 3 will now be discussed further. Apparatus 104 includes the processor 202, e.g., a CPU, acting as a controller, e.g., illumination device controller. a camera/synchronization controller and/or vehicle operation controller, an input device 1006, e.g., a keypad, an output device 1008, e.g., a display, an assembly of hardware components 1010, e.g., an assembly of circuits, memory 204, the plurality of cameras (camera 1 114, camera 2 116, C3 174, C4 176), speed control circuitry 1034, braking control circuitry 1030, steering control circuitry 1032, an autopilot system 1037, and a collision avoidance system 1039 coupled together via a bus 1009 over which the various components may interchange data and information. In some embodiments, the autopilot system 1037 and/or the collision avoidance system 1039 are coupled together and/or to the speed control circuitry 1034, braking control circuitry 1030 and/or steering control circuitry. Apparatus 104 further includes engine/fuel/transmission components 1036, e.g., a motor, internal combustion and/or electric, computer controlled fuel injection system, electronically controlled transmission, etc., which is coupled to speed control circuitry 1034. Apparatus 104 further includes brake system components 1038, e.g., ABS system, brake sensors, wheel motion sensors, wheel position sensors, actuators, hydraulic components, electronically controlled brakes, etc., coupled to braking control circuitry 1030. Apparatus 104 further includes steering system components 1040, e.g., rack and pinion unit, steering input controls and steering drive components including motors, etc., coupled to steering control circuitry 1032. In some embodiments, the steering control circuitry 1034, braking control circuitry 1030 and/or steering control circuitry 1032 is part of an autonomous or semi-autonomous driving control system and/or an assisted driving control system. A wireless interface 1005, e.g., including a wireless radio transmitter and receiver, which allows the controller 202 to communicate captured images to a cloud based image processing system and to receive depth map information generated from captured images back from the cloud based system.

Memory 204 includes an assembly of software components 1050, e.g., an assembly of software routines or software modules, and data/information 1052. Memory 204 includes stored information (SI) 1061, which can include image data as well as other information. SI 1061 includes, in some embodiments, one more or all of: depth information generated from captured images, generated models, e.g., 2D and/or 3D object recognition models, non-patterned images of an object and/or area, and/or illumination patterned images of the object and/or area.

Assembly of software components 1050 includes one or more passband filters 205, which are used to filter images to generate bandlimited illumination images/patterns, illumination control routine (ICR) 1051, an image processing and/or combining routine 1057, an image portion matching routine 1070 and a depth map routine 1072. ICR 1051, when executed by controller 202, controls the apparatus 104 to display a sequence of one or more images, included in stored illumination pattern information 1053 by causing the illumination device 108 to output, e.g., display by projection, the image pattern or patterns selected to be used for illumination purposes at a given time. Different illumination images included in data 1053 have different resolutions and/or different frequency content with the frequency content of different images being limited to different frequency bands in at least some embodiments. An illumination image which was passband filtered, to limit the frequency content to a particular passband to which the passband used to generate the image corresponds, is sometimes referred to as a bandlimited image due to the band limiting nature of the passband filtering operation used to generate such an image. Some images include more details than other images. Some illumination images correspond to a band having more high frequency content than one or more other images corresponding to another band limiting filtering operation which removed high frequency image content.

Image processing and/or combining routine 1057 in some embodiments combines images showing a pattern captured by one or more cameras to produce an image in which the pattern is not visible. Routine 1057, in some embodiments, also performs processing relating to model generation and/or stores information associating depth data, e.g., a depth map, generated from stereoscopic images captured by e.g., cameras C1 114, C2 116.

Data/information 1052 includes captured images (captured image 1 1054, . . . , captured image Z 1056), generated, e.g. non-pattern images 1059, a generated depth map 1058, e.g., generated from captured images, and a generated vehicle control command 1060, e.g., to be sent to speed control circuitry 1034, braking control circuitry 1030, steering control circuitry, autopilot system 1037 and/or collision avoidance system 1039, e.g. in response to a detected change and/or problem, detected by analyzing the generated depth map, e.g., a stopped or disabled truck, a person or another robotic device suddenly is detected in front of the robotic device/vehicle resulting in a control command for avoidance. Depending on the exposure time and/or length of exposure, in some but not all embodiments, some captured images 1054, 1056, will include a visible illumination pattern while in other captured images, e.g., having a different exposure duration and/or start time than an image showing an illumination pattern, will not show an illumination pattern. In some embodiments one or more non-patterned images 1059 are generated by processing routine 1057 combining images showing an illumination pattern present in all or a portion of an illumination frame display period and/or an illumination pattern (e.g., concealing pattern) present in all or a portion of a concealing frame display period. Routine 1057, in some embodiments, simply averages and/or time averages corresponding pixels of images (e.g., captured frames) being combined so that the combined image has pixel values which correspond to what would have been obtained if a single image was captured by using an exposure time corresponding to the total exposure time of the images being combined. Note that when generating an image that does not include a pattern, routine 1057 may crop and/or resize an image to elimination portions which are not of interest, e.g., portions which do not include an illumination pattern or concealing pattern or which show objects or surfaces which are not of interest. For example, when a product or object is being illuminated and inspection is being performed, image processing routine 1057 may, and often will, delete the portions of a captured image which are not of interest. Thus, the stored and/or generated images produced by image processing routine 1057, e.g., images which can, but often do not, include an illumination pattern, may be, and sometimes are, images of an object of interest which is to be inspected, measured in 3D and/or modeled.

Apparatus 104 can be any of a wide range of devices including any of: a robotic device, a product inspection device, an image capture device, a 3D model generation device, a land vehicle, e.g., a car, truck, motorcycle, bicycle, train, unmanned terrestrial vehicle, etc., a sea or water vehicle, e.g., boat, ship, unmanned water vehicle, etc., amphibious vehicle, air vehicle, e.g., airplane, helicopter, glider, unmanned aerial vehicle, etc.

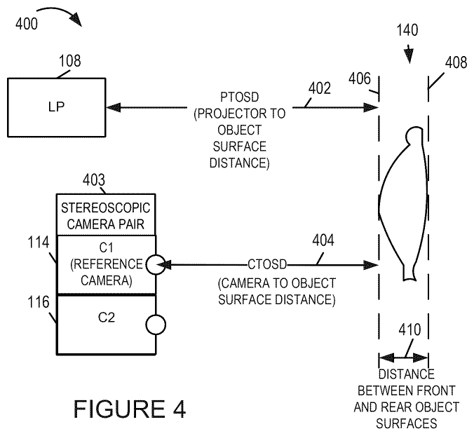

To help understand various features of the invention, FIG. 4 shows a diagram 400, showing the relationship between a light projector 108, illuminated surfaces, e.g., front 406 and rear 408 surfaces and cameras 114, 116 of a stereoscopic camera pair 403, along with various distances 402, 404 and 410, which can help in understanding various aspects of the invention relating to illumination pattern frequency band limiting and/or selection of image patterns having different resolutions and/or frequency content, based on one or more distances. The distance used in selection of the illumination pattern to use includes the projector to object surface distance (PTOSD) 402 and/or the camera to object surface distance (CTOSD) 404. In the example, the PTOSD 402 corresponds to the distance from the projector 108 to the front surface 406 of the object 140. As should be appreciated, when the projector 108 is far away from the object 140 the image will be projected over a larger area than when the projected image is closer to the object 140. The image/pattern resolution on the surface(s) of the object 140 is what will be observed by the cameras 114, 116, and it is this displayed resolution which should be able to be accurately captured by the cameras 114, 116 for accurate depth estimate. Ideally the resolution and/or frequency content of the projected image on the surface(s) of the object 140 should be as close as possible to the maximum resolution that can be captured by the cameras 114, 116 without aliasing or other errors.

The ability of the camera 114, 116 to capture details/image content of a projected image depends on the cameras proximity to the surface, on which the image is projected, as represented by the distance CTOSD 404. In various embodiments the closer the cameras C1 114, C2 116 are to the surface on which an illumination image is projected, the more detail in the image they will be able to capture.

While the distance 410 represents the distance between the front surface of the object 140 and the rear surface 408 of the object 140 this distance tends to be smaller than the PTOSD 402 or the CTOSD 404 and can generally be ignored when selecting an illumination pattern/image to be projected for depth measurement purposes. However, once an initial depth determination is made, rather than use the front surface as the surface to which the CTOSD and PTOSD are measured, the distance to another surface of the object 140 can be used as the CTOSD or PTOSD or the distance between the front surface 406 and rear surface 408 can be used to determine the CTOSD and PTOSD, with the distances being to a center between the front 406 and rear 408 object surfaces in some embodiments.

In some embodiments the CTOSD or PTOSD may be fixed, e.g., due to the cameras 114, 116 or projector 108 being at a fixed position relative to the object 140 to be measured. In such cases selection of which image to use at a given time may be based on the distance CTOSD or PTOSD that changes and the current value for the distance at the time an image/pattern is being selected for illumination purposes. However, in other embodiments both the CTOSD or PTOSD may change due to movement of the device 104, the cameras 114, 116, the light projector 108 and/or the object 140.

Selecting the illumination pattern image to project, in many embodiments, is based on both the CTOSD and PTOSD (e.g., the ratio PTOSD:CTOSD, which may also be expressed as PTOSD/CTOSD) rather than simply the CTOSD or PTOSD alone.

A higher PTOSD:CTOSD ratio lets, and/or leads to, an image with a higher frequency content limit, e.g., band limit, being selected as the illumination image to project. A lower PTOSD:CTOSD ratio causes an image with a lower frequency content limit, e.g., band limit, to be used. This is because a larger PTOSD tends to result in a lower resolution image being displayed on the surface and a smaller PTOSD with the cameras having to capture less image information per unit of object surface area to accurately capture the displayed image than would be required. The larger the CTOSD the farther away the camera is from the object surface. This results in the camera being able to capture detail per unit area of object surface accurately as the CTOSD increases, since the camera's sensor resolution is fixed regardless of the distance to the object being observed. Thus as CTOSD increases, it is desirable to decrease the resolution and/or frequency content of the image being projected by using a bandlimited image which is bandlimited to a lower frequency range than an image used when the CTOSD is smaller and the PTOSD remains the same. Since both PTOSD and CTOSD can affect a camera's ability to accurately capture an image of a pattern or image projected on a surface, it is useful to consider a ratio of PTOSD:CTOSD when making an image selection for illumination purposes. However, where one of these values is constant, the decision as to which image to use as an illumination image at a given time can be based on the distance PTOSD or CTOSD which can change.

In at least some embodiments the PTOSD, CTOSD, or PTSOD to CTOSD ratio are compared to thresholds, used to determine which of a plurality of bandlimited images is selected to be projected by the illumination device as the image/pattern used to illuminate the object surface. Ranges are associated with each image, and if the PTOSD, CTOSD or PTSOD:CTOSD ratio being used to determine the illumination image to use matches the range associated with the image, the image will be selected and used as the illumination image which is projected.

In some embodiments where an illumination selection is between images of different resolutions, ranges of PTSOD, CTOSD or PTSOD to CTOSD values are associated with different images, e.g., having different resolutions and the illumination image to use is the one having an associated range corresponding to the PTOSD, CTOSD, or PTSOD to CTOSD ratio being used to select the illumination image.

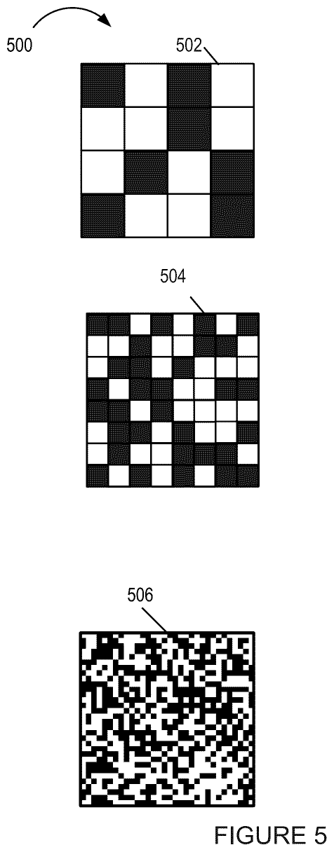

FIG. 5 is a diagram 500 showing 3 different resolution images 502, 504, 506, e.g., illumination patterns, which can be projected onto a surface from light projector 108. The illumination pattern 502 is a low resolution pattern to be used when the cameras are far away from the illuminated surface in which case they will have difficulty detecting fine details and thus a low resolution image is preferrable as the illumination image, since the camera 114, 116 will be more likely to accurately detect the features of the low resolution image. Thus low resolution image pattern 502 is, in some embodiments, is associated with a first PTOSD range which include long PTSDs.

The medium resolution image 504 is to be used when cameras are a medium distance from an illuminated object surface and is associated with a second PTOSD range, e.g., a medium PTOSD range. PTSODs in the medium PTOSD range are smaller/shorter than PTOSDs in the long PTOSD range associated with image pattern 502.

The high resolution image 506 is to be used, in some embodiments, when the cameras 114, 116 used for depth determination are a short distance from an illuminated object surface. High resolution image 506 is associated with a third PTOSD range, e.g., a short PTOSD range. PTSODs in the short PTOSD range are smaller/shorter than PTOSDs in the medium or long PTOSD ranges.

The images 502, 504, 506 are, from the perspective of the projector 108, the same size, but the size of the images, when they illuminate a surface of an object such as the object 140 will depend on the distance to the surface on which the light falls, e.g., the projector to object surface distance (PTOSD) 402.

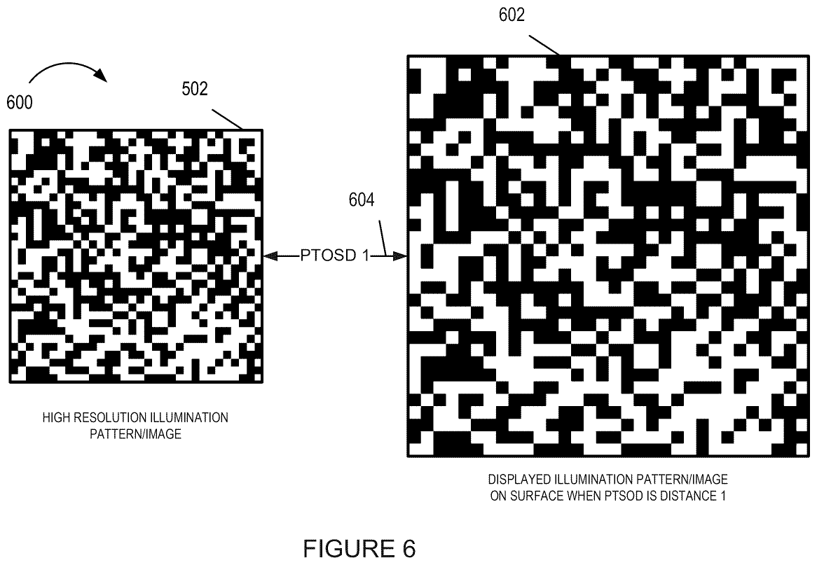

FIG. 6 is a diagram 600 showing that the size of the projected image on the illuminated surface will depend on the distance between the illumination projector and illuminated surface, given the optics of the illumination device 108, which tend to enlarge a projected image, with the size of the displayed image being larger the farther the illuminated surface is away from the illumination projector 108. On the left side of FIG. 6, the high resolution illumination pattern 502 is shown, while on the right side of FIG. 6 the larger image 602 of the illumination pattern, is shown as it will appear when projected onto a surface at a distance PTOSD 1 602 from the illumination projector 108. The image is noticeably large on the surface onto which it is projected, with the physical size of individual blocks forming the image 602, being large than the blocks in image 502.

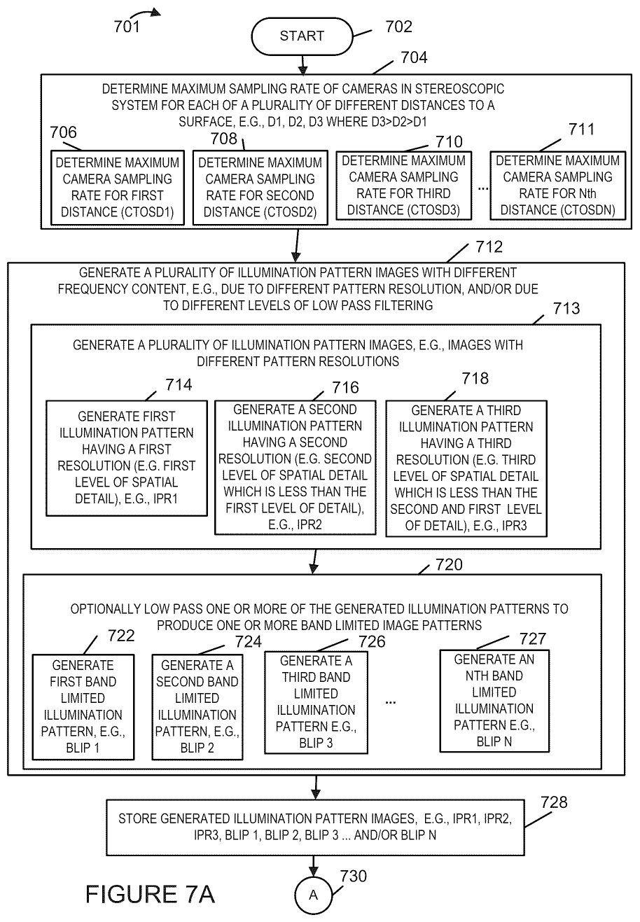

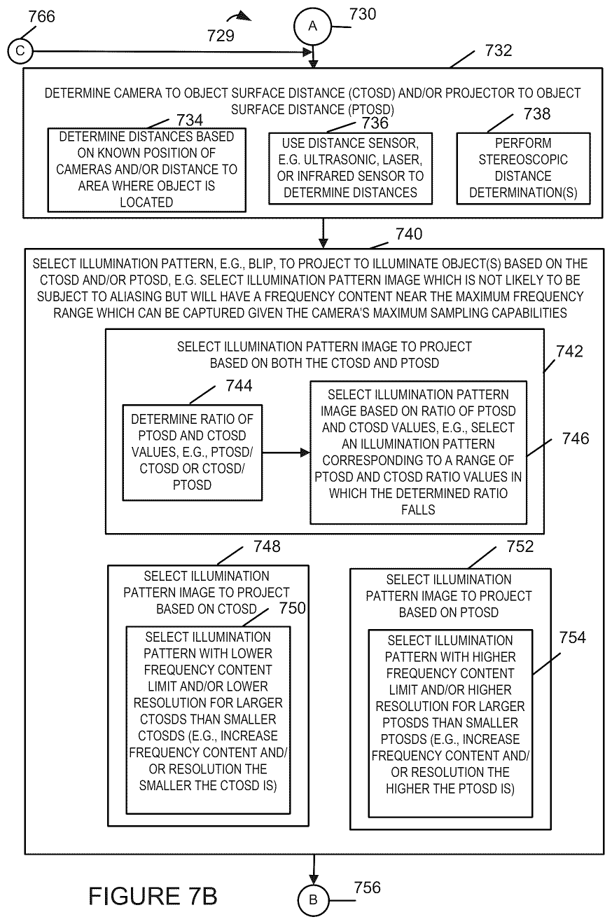

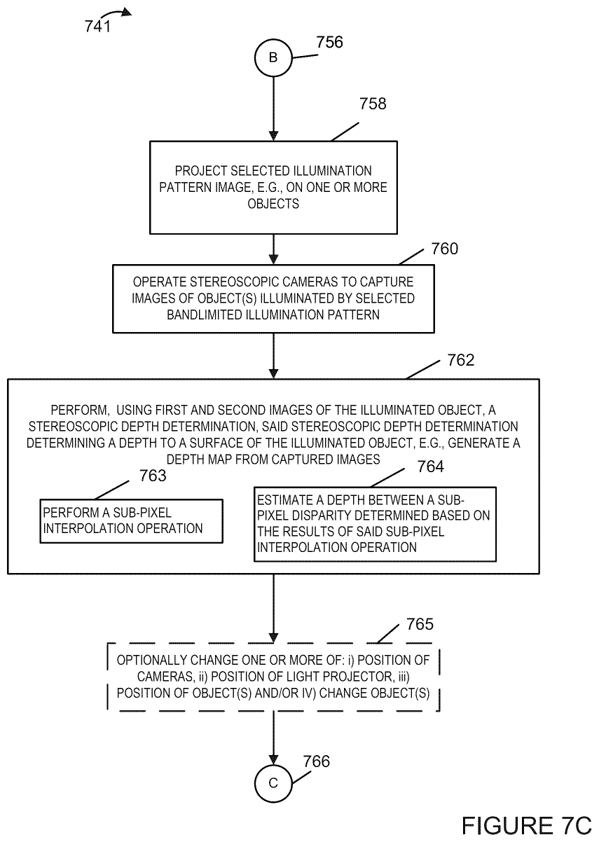

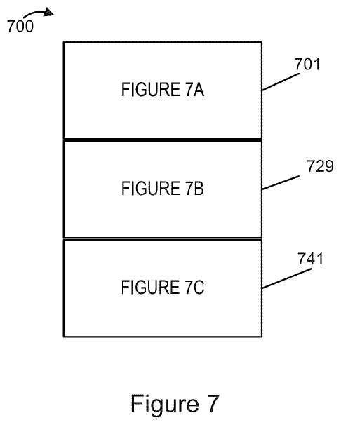

An exemplary method of generating, selecting and using bandlimited illumination patterns, e.g., images, to support and perform stereoscopic depth determination operations will now be discussed with regard to FIG. 7, which shows a method 700, which includes the steps of the flow chart portions 701, 729 and 741 shown in FIGS. 7A, 7B and 7C respectively. The flow chart portions 701, 729 and 741 can be combined as shown in FIG. 7 to form a complete flow chart including the steps of the method 700.

The method 700 can be, and sometimes is, implemented by an apparatus, such as the apparatus 104, which includes a processor 202, memory 204, light projector 108 and one or more pairs of stereoscopic cameras (114, 116), (174, 176).

The method 700 starts in step 702, e.g., with the apparatus 104 being powered on. Operation proceeds from start step 702 to step 704 in which the maximum sampling rate of the cameras (114, 116) or (174, 176) being used for stereoscopic depth determination purposes is determined for each of a plurality of different camera to object surface distances (CTOSDs).

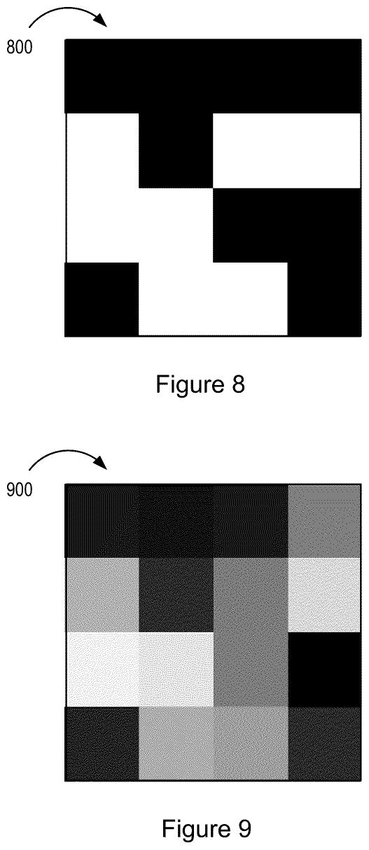

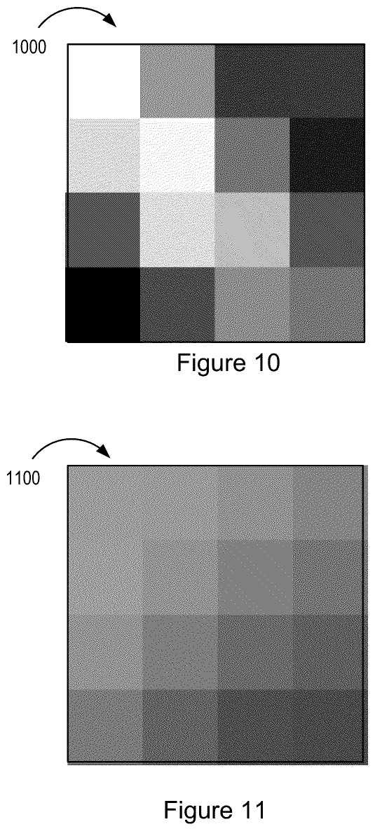

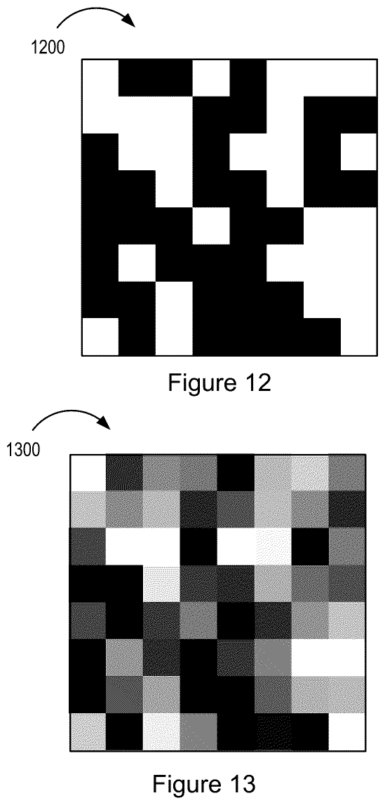

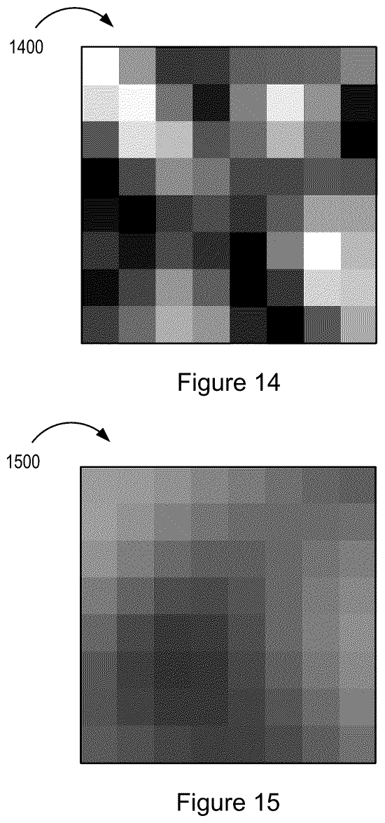

This can be done based on stored information about the capabilities of the camera/lens combinations being used and/or through actual measurements. In some embodiments maximum supported camera sampling rate information is stored for a range of distances in memory and is simply accessed in step 704. In some embodiments in step 704 at least three different maximum sampling rates are determined, each corresponding to a different CTOSD, but in some embodiments 9 or more maximum sampling rates are determined, each for a different CTOSD. For example, in one exemplary embodiment, 3 maximum sampling rates are determined for distances for which a low resolution image, e.g., the image 800 shown in FIG. 8, is the basis of the illumination images (e.g., 3 different bandwidth limited filtered versions of the low resolution image, e.g., image 900 shown in FIG. 9, image 1000 shown in FIG. 10 and image 1100 shown in FIG. 11, each corresponding to frequency bands with different upper limits) which may be selected, another 3 maximum sampling rates are determined for distances for which a medium resolution image, e.g., image 1200 shown in FIG. 12, is the basis for the filtered illumination images which may be selected. The medium resolution filtered images which can be selected include, for example image 1300 shown in FIG. 13, image 1400 shown in FIG. 14 and image 1500 shown in FIG. 15. These images 1300, 1400, 1500 are generated by filtering image 1200 using a low pass bandpass filter with different upper frequency cutoffs with the FIG. 15 image 1500 being generated using the lowest of the upper frequency cutoffs used to generated FIGS. 13, 14, and 15.

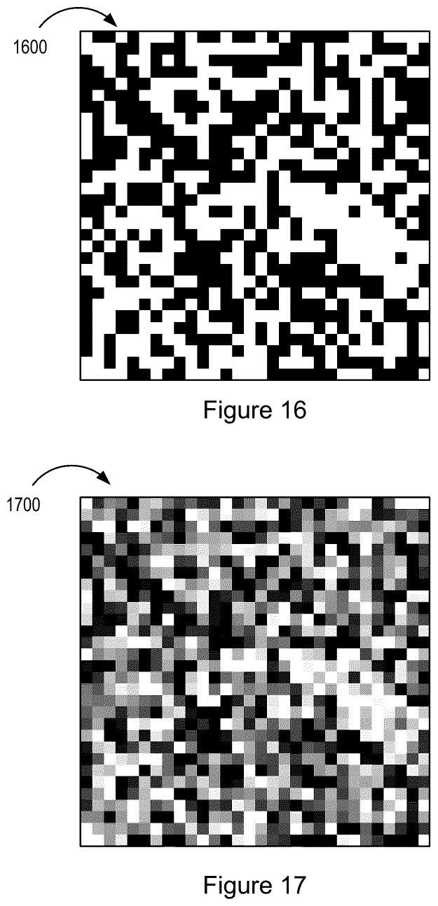

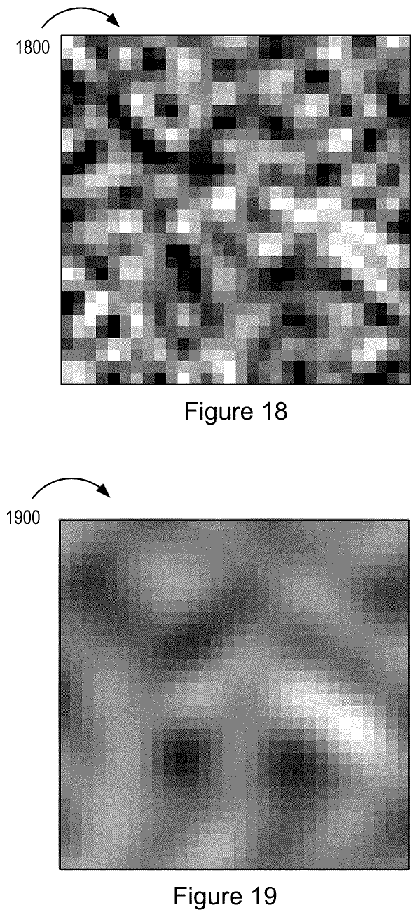

Another 3 maximum sampling rates are determined for 3 different distances for which a high resolution image, e.g., image 1600 shown in FIG. 16, is the basis of the illumination images, e.g., image 1700 of FIG. 17, image 1800 of FIG. 18 and image 1900 of FIG. 19. which may be generated. In such an embodiment 9 illumination images, generated by performing a low pass bandpass filtering operation in some embodiments, are available for selection with each having a different amount of frequency content due to using different upper frequency cutoffs for the low pass filter used to generate the images. A choice is dynamically made between which illumination image to use at a given time so that the selected image has a pattern with content which is withing the camera's Nyquist sampling rate, fn, which is the minimum rate at which a signal, e.g., visual image in the case of a camera capturing pixel values representing an image, object or scene, can be sampled without introducing distortion, specifically aliasing. To avoid errors the maximum frequency content of the illumination image displayed should be equal to or less than 2fm, where fm is the maximum frequency content of the image on the surface of an object being captured.

The sampling performed by a camera depends on the size of the area being sampled and thus the CTOSD and/or PTOSD play a role in determining what image or images, when projected onto a surface of an object, can be sampled without introducing distortion as part of the sampling, e.g., image capture process. This is in part due to the fact that the sensor used in the cameras can capture a limited number of pixels (pixel values). When the size of a scene area captured increases, the captured image resolution, e.g., samples per unit area, effectively decreases and the ability to detect details in an image and/or other features corresponding to high frequencies may be lost.

In some embodiments step 704 includes steps 706, 708, 710 and 711. In step 706 a maximum camera sampling rate that can be supported, e.g., the maximum sampling rate that a camera can achieve for a first distance CTOSD1 is determined, with this rate corresponding to a first maximum frequency range which can be sampled reliably, e.g., without creating aliasing errors. In step 708 a maximum camera sampling rate that can be supported, e.g., the maximum sampling rate that a camera can achieve for a second distance CTOSD2 is determined, with this rate corresponding to a second maximum frequency range which can be sampled reliably, e.g., without creating aliasing errors. In step 710 a maximum camera sampling rate that can be supported, e.g., the maximum sampling rate that a camera can achieve for a third distance CTOSD3 is determined, with this rate corresponding to a third maximum frequency range which can be sampled reliably, e.g., without creating aliasing errors. In step 711 a maximum camera sampling rate that can be supported, e.g., the maximum sampling rate that a camera can achieve for an Nth distance CTOSDN is determined, with this rate corresponding to a Nth maximum frequency range which can be sampled reliably, e.g., without creating aliasing errors.

In some embodiments N is 9 but this number is exemplary and is normally a number which will provide enough information to allow for selection between a plurality of possible illumination images so that an illumination image can be selected having frequency content that can be reliably sampled without errors and yet include a level of detail which facilities depth determination with more detail being preferrable to less detail for depth determination purposes. Accordingly, the maximum sampling rate supported by the cameras being used at a given distance determines the frequency range/image content which can be captured without introducing aliasing errors into the captured image.

Operation proceeds from step 704 to illumination pattern, e.g., image, generation step 712 in which a plurality of illumination images, e.g., illumination pattern images, with different frequency content, e.g., due to different pattern resolution and/or due to different levels of low pass filtering are generated. Lowpass images are a form of band limited images since the filtering limits the frequency content to a particular frequency band e.g., determined in part based on the upper cutoff frequency of the bandpass filter used to implement the filtering operation used to generate the bandlimited illumination image. While filtered illumination patterns (900, 1000, 1100, 1300, 1400, 1500, 1700, 1800, 1900) are used in some embodiments for the illumination images, in other embodiments images (800, 1200, 1600) which were not filtered but of different resolutions are used as the illumination images based on the fact that higher resolution images will normally tend to have higher frequency content than lower resolution images particularly if the image content is random or pseudo random in nature.

The generated illumination patterns can be any of a wide variety of patterns including random or pseudo random patterns, and can be color, grayscale or monochrome patterns depending on the embodiment.

In some embodiments step 712 includes steps 713 and 720. In step 713 a plurality of illumination pattern images, e.g., images with different pattern resolutions are generated. This may, and sometimes does, involve generating three or more illumination patterns with different resolutions. In the embodiment shown in FIG. 7, step 713 includes steps 714, 716 and 718. In step 714 a first illumination pattern/image, e.g., pattern 800 shown in FIG. 8, having a first resolution, e.g., a first low level of spatial detail, is generated. IPR1, which stands for Illumination Pattern Resolution 1, is used when explaining the invention to refer to a low resolution pattern. In step 716 a second illumination pattern, e.g., pattern 1200 shown in FIG. 12, having a second resolution, e.g., a medium level of spatial detail, is generated. IPR2, which stands for Illumination Pattern Resolution 2, is used when explaining the invention to refer to a medium resolution pattern. In step 718 a third illumination pattern, e.g., pattern 1600 shown in FIG. 16, having a third resolution, e.g., a high level of spatial detail, is generated. IPR3, which stands for Illumination Pattern Resolution 3, is used when explaining the invention to refer to a high resolution pattern.

With multiple illumination patterns of different resolutions having been generated in step 713 operation proceeds to step 720. In step 720 one or more of the illumination patterns generated in step 713 are subjected to a frequency bandlimiting operation, e.g., a low pass bandpass filtering operation, to produce one or more bandlimited illumination patterns with a predictable maximum frequency content, fm. As should be appreciated, the maximum frequency content of an illumination image/pattern generated in step 720 is a function of a bandpass filter upper frequency cutoff of the bandpass filter used to allow low frequency content to remain in the generated image while eliminating high frequency content, e.g., frequency content above the maximum frequency fm.

In some embodiments each of the images generated in steps 714, 716, 718 are subject to low pass passband filtering using filters with different upper frequency cutoffs to generate multiple, e.g., 3 in some embodiments, different bandlimited illumination images/patterns from each of the illumination patterns generated in steps 714, 716, 718.

Step 720 includes, in some embodiments, steps 722, 724, 726 through 727. In each of steps 722, 724, 726, 727 a different band limited illumination pattern, having a different maximum frequency, is generated so that N different illumination patterns are generated and available for selection.

In step 722 a first band limited illumination pattern BLIP 1 is generated. BLIP 1 may be, and sometimes is, generated by applying a low pass bandpass filter with an upper cut off frequency F3 to the low resolution image 800 of FIG. 8 to produce the bandlimited illumination pattern/image 900 of FIG. 9. In step 724 a second band limited illumination pattern BLIP 2 is generated. BLIP 2 may be, and sometimes is, generated by applying a low pass bandpass filter with an upper cut off frequency F2 to the low resolution image 800 of FIG. 8 to produce the bandlimited illumination pattern/image 1000 of FIG. 10. In step 726 a third band limited illumination pattern BLIP 3 is generated. BLIP 3 may be, and sometimes is, generated by applying a low pass bandpass filter with an upper cut off frequency F1 to the low resolution image 800 of FIG. 8 to produce the bandlimited illumination pattern/image 1100 of FIG. 11. In such an embodiment F3>F2>F1, which results in BLIP 1 900 having a higher maximum frequency content than BLIP 2 1000, which in turn has a higher maximum frequency content than BLIP 3 1100.

Step 720 includes N image generation steps with the Nth bandlimited illumination pattern BLIP N being generated in step 727 using a bandpass filter having an upper cutoff frequency that is different than the upper cutoff frequencies used to generate the other bandlimited illumination image patterns. In the case where N is 9, step 727 will result in a ninth bandwidth limited illumination pattern being generated.

With a plurality of bandwidth limited illumination images, each having image content with a different maximum frequency fm, operation proceeds to step 728 wherein the bandwidth limited images are stored, e.g., in memory 204 as part of the illumination pattern information and/or images 1053. As part of storage step 728 the unfiltered illumination patterns generated in step 713 can also be stored with these patterns each having, in some embodiments, different maximum frequency content from each other and/or the bandlimited images generated in step 720.

With the different generated illumination images having been stored in step 728, the stored illumination images are available to be selected and used for illumination purposes. Operation proceeds from step 728 to step 732 of FIG. 7B via connecting node A 730.

In step 732 a camera to object surface distance (CTOSD) and/or projector to object surface distance (PTOSD) is determined. In some embodiments the CTOSD is the distance from the front of one of the cameras 114 or 116 to the surface of an object to be measured, while the PTOSD is the projector to the object surface distance. Depending on the apparatus 104 on which the cameras 114, 116 and projector 108 are mounted, the distances can change as the apparatus 104 moves relative to the object being measured and/or an individual component on which the cameras 114, 116 or projector 108 are mounted moves with the cameras and projector potentially moving independent of one another. To determine the distance(s) one or more sensors may be used, a known relationship between the location of the apparatus 104 and object 140 to be measured may be used and/or distances can be determined from stereoscopic measurements. In some embodiments step 732 includes one, more than one or all of steps 734, 736 and 738.

In step 734 the CTOSD and/or PTOSD is determined based on known position information indicating the position of the cameras 114, 116, location of the object 140 to be measured and/or stored information indicating the distance between the cameras 114, 116 and object 140 and/or stored information indicating the distance from projector 108 to object 140. In step 736 the CTOSD and/or PTOSD are determined based on distance information obtained from one or more distance sensors associated with the camera(s) 114, 116 and/or illumination projector 108. The sensors can be, and sometimes are, ultrasonic sensors, laser and/or infrared based sensors. The accuracy of such sensors can be and sometimes is less than the accuracy of depth/distance determinations generated using stereoscopic depth determination techniques.

In step 738 the CTOSD and/or PTOSD are generated using stereoscopic depth/distance determinations based on captured images. While the first time stereoscopic distances are determined they may be, and sometimes are, determined using an illumination pattern which is an initial default pattern, e.g., a medium resolution pattern or an illumination pattern selected based on an expected distance to the object 140 to be measured, once a distance is determined through a stereoscopic distance determination, the determined distance can be, and sometimes is, used to select the illumination image pattern to be used for the next depth/object measurement operation. Thus, as the apparatus 104 moves, different CTOSDs and/or PTOSDs will be determined, with the selected illumination pattern being based on the most recently determined depth in some embodiments.

With a CTOSD and/or PTOSD having been determined in step 732, operation proceeds to step 740, in which an illumination pattern, e.g., a bandwidth limited illumination pattern, is selected to be used to illuminate an object or surface, which will be the subject of a stereoscopic depth measurement. The selection is based on the CTOSD and/or PTOSD. The selection process takes into consideration the maximum frequency (fm) of the illumination patterns available for use.

In step 740, in some embodiments, an illumination pattern/image is selected which will not be subject to aliasing when the illumination pattern is projected onto the surface of the object being measured. In step 740, in some embodiments, an illumination pattern which will not be subject to aliasing and/or is not likely to be subject to aliasing will be selected but with the selected image having a frequency content near or within a fixed range of the maximum frequency range that can be captured by the cameras 114, 116 without the introducing errors/aliasing into the captured images(s).

In various embodiments step 740 involves selecting an illumination pattern image which, when projected onto the object 140 will have a displayed maximum frequency fm less than or equal to ½ the Nyquist sampling rate. In some embodiments an illumination image which was bandlimited to ½ fs or less than ½ fs, where fs is the sampling rate of the cameras 114, 116 being used, is selected. In some embodiments the illumination image is selected to have a maximum frequency fm in the range of 0.3 to 0.5 fs (the camera sampling frequency or Nyquist frequency fn of the cameras) but this range is exemplary and other ranges are possible such as 0.25 to 0.5 fs which is used in some embodiments

To facilitate selection of an illumination pattern, in some embodiments bandlimited illumination pattern images were generated and stored so that a selection can be made between the prestored images dynamically, e.g., based on changes to the CTOSD and/or PTOSD.

Step 740 includes one, more or all of steps 742, 748, and 752 depending on the embodiment. In many embodiments the method includes step 742 in which the illumination pattern image to project is based on both the CTOSD and PTOSD. In some such embodiments step 742 includes both steps 744 and step 746. In step 744 a ratio is generated based on the CTOSD and PTOSD, e.g., a PTOSD:CTOSD ratio or a CTOSD:PTOSD ratio is generated in step 744 and then an illumination pattern e,g, one of the stored bandwidth limited illumination patterns, is selected to be used to illuminate the object 140 based on the value of the determined ratio.

A larger PTOSD tends to result in a lower resolution image being displayed/visible on the surface of the object since the image is projected over a large area, thereby decreasing the displayed resolution on the object surface, as compared to when the projector is closer to the object. While the closer the camera(s) 114, 116 are to a surface of an object on which an image pattern is projected, the easier it is for them to detect high resolution/high frequency content. Thus as the CTSOD decreases, the frequency content of the illumination image can be increased.

Since both PTOSD and CTOSD can affect a camera's ability to accurately capture an image of a pattern or image projected on a surface, it is useful to consider a ratio of PTOSD:CTOSD when making an image selection for illumination purposes. However, where one of these values is constant, the decision as to which image to use as an illumination image at a given time can be based on the distance PTOSD or CTOSD which can change.

In at least some embodiments the PTOSD, CTOSD, or PTSOD to CTOSD ratio are compared to thresholds, used to determine which of a plurality of bandlimited images is selected to be projected by the illumination device as the image/pattern used to illuminate the object surface. Ranges are associated with each image, and if the PTOSD, CTOSD or PTSOD:CTOSD ratio being used to determine the illumination image to use matches the range associated with the image, the image will be selected and used as the illumination image which is projected.

In some embodiments where an illumination selection is between images of different resolutions, ranges of PTSOD, CTOSD or PTSOD to CTOSD values are associated with different images, e.g., having different resolutions and the illumination image to use is the one having an associated range corresponding to the PTOSD, CTOSD, or PTSOD to CTOSD ratio being used to select the illumination image.

In step 742, higher PTOSD:CTOSD ratio lets, and/or leads to, an image with a higher frequency content limit, e.g., band limit, being selected as the illumination image to project. Thus, a higher PTOSD:CTOSD ratio will result in a bandwidth limited illumination image having a higher maximum frequency fm being selected in step 742, than when a different lower PTOSD:CTOSD ratio is determined. Similarly, a low PTOSD:CTOSD ratio causes an image with a lower frequency content limit, e.g., bandlimit, to be selected and used, than when a higher PTOSD:CTOSD ratio is determined.

If a CTOSD-PTOSD ratio is used in step 742 the inverse selection will be made with a higher CTOSD-PTOSD ratio resulting in an image with a lower frequency content limit, e.g., band limit or lower fm, being selected as the illumination image to project.

In some embodiments step 740 includes step 748 in which the illumination pattern image, e.g., stored bandwidth limited illumination pattern to be used, is selected based on the CTOSD, e.g., without determining or using of the PTOSD as part of the selection decision making process. Such an approach is well suited for applications where ethe PTOSD remains fixed, e.g., because the projector 108 location is fixed relative to the object 140 to be measured while the CTOSD may change, e.g., due to camera movement and/or movement of the apparatus 104. In some embodiments step 748 includes step 750 in which an illumination pattern with a lower frequency content limit, e.g., lower fm, and/or lower resolution is selected when a large CTOSD is detected than when a lower CTOSD is detected. For example, if the cameras 114, 116 are close to the object 140 in such a case a bandlimited illumination image with a higher maximum frequency content, higher fm, will be selected than when the CTOSD is large, indicating the cameras 114, 116 are farther away from the object and thereby making it difficult for them to resolve details/high frequency image content.

In some embodiments step 740 includes step 742 in which the illumination pattern image, e.g., stored bandwidth limited illumination pattern to be used, is selected based on the PTOSD, e.g., without determining or using of the CTOSD as part of the selection decision making process. Such an approach is well suited for applications where the CTOSD remains fixed, e.g., because the location of cameras 114, 116 is fixed relative to the object 140 to be measured while the PTOSD may change, e.g., due to projector 108 movement and/or movement of the apparatus 104. In some embodiments step 752 includes step 754 in which an illumination pattern with a higher frequency content limit, e.g., higher fm, and/or higher resolution is selected when a large PTOSD is detected than when a lower PTOSD is detected. For example, if the projector 108 is close to the object 140, in such a case a bandlimited illumination image with a lower maximum frequency content will be selected than when the PTOSD is larger indicating the projector 108 is farther away from the object 140 resulting in the details of the projected illumination image appearing larger on the object surface than they would appear if the projector 108 was closer to the object 140.

With an illumination pattern to project having been selected in step 740, e.g., based on the CTOSD, PTOSD and/or frequency content (or resolution) of the illumination images available for projection, operation proceeds to step 758 via connecting node B 756.

In step 758 the apparatus 104, under control of the processor 202, controls the projector 108 to project the selected illumination image on one or more objects to be measured, e.g., on object 140. Then in step 760 the stereoscopic camera 114, 116 of a stereoscopic camera pair are controlled to capture images, e.g., first and second images respectively, of the illuminated object(s) 140, e.g., at the same time while the object is illuminated using the selected illumination pattern, e.g. bandwidth limited illumination pattern selected in step 740 based on the PTOSD and/or CTOSD.

With images, e.g., first and second images captured by first and second cameras 114, 116, having been captured in step 760 and available for processing, operation proceeds to step 762, in which a stereoscopic depth determination is made based on the first and second images, e.g., a depth map corresponding to the object 140 is generated by performing stereoscopic processing on the first and second images captured in step 760. In some embodiments in step 762 includes performing a sub-pixel interpolation operation in step 763 followed by, in step 764, by making an estimation of a depth between a sub-pixel disparity determined based on the results of the sub-pixel interpolation operation performed in step 763. The depth map generated in step 762 includes distance measurements of the object 140 and in some embodiments represents a 3D model of the object or at least the portion of the object 140 visible in the first and second images captured by the stereoscopic camera array including cameras 114, 116.

Over time the location of the cameras 114, 116, the location of the light projector 108 and/or the location of the object(s) 140 to be measured may change. This can result in a change of the CTOSD and/or PTOSD. Step 765 represents such a change which may occur for a variety of reasons including movement of the apparatus 104 or arm 105. To ensure that an appropriate illumination pattern image is used when there is a change, operation proceeds from step 765 via connecting node C 766 to step 732 so that the CTOSD and/or PTOSD can be redetermined and an appropriate illumination pattern selected given any change in distances.

Thus in accordance with the invention bandwidth limited images can be dynamically selected so that a suitable image, which will not result in aliasing, will be used at any given time while ensuring that a resolution which is significantly sub-optimal is not selected for use.

FIG. 8 shows an unfiltered exemplary low resolution illumination pattern, e.g., a black and white illumination pattern.

FIG. 9 shows a first low resolution filtered illumination pattern, e.g., a grayscale image pattern, generated by filtering the illumination pattern of FIG. 8, using a bandpass filter, which limits the maximum frequency of the image, generated by filtering the image shown in FIG. 8, to reduce the upper frequency content of the image, based on an upper cutoff frequency, F3, of the bandpass filter, used to filter the image of FIG. 8.

FIG. 10 shows a second low resolution filtered illumination pattern, e.g., a grayscale image pattern, generated by filtering the illumination pattern of FIG. 8, using a bandpass filter, which limits the maximum frequency of the image, generated by filtering the image shown in FIG. 8, to reduce the upper frequency content of the image, based on an upper cutoff frequency, F2, of the bandpass filter, used to filter the image of FIG. 8, where F2<F3.

FIG. 11 shows a third low resolution filtered illumination pattern, e.g., a grayscale image pattern, generated by filtering the illumination pattern of FIG. 8, using a bandpass filter, which limits the maximum frequency of the image, generated by filtering the image shown in FIG. 8, to reduce the upper frequency content of the image, based on an upper cutoff frequency, F1, of the bandpass filter, used to filter the image of FIG. 8, where F1<F2<F3.

FIG. 12 shows an unfiltered exemplary medium resolution illumination pattern, e.g., a black and white illumination pattern.

FIG. 13 shows a first medium resolution filtered illumination pattern, e.g., a grayscale image pattern, generated by filtering the illumination pattern of FIG. 12, using a bandpass filter, which limits the maximum frequency of the image, generated by filtering the image shown in FIG. 9, to reduce the upper frequency content of the image, based on an upper cutoff frequency, F6, of the bandpass filter, used to filter the image of FIG. 12.

FIG. 14 shows a second medium resolution filtered illumination pattern, e.g., a grayscale image pattern, generated by filtering the illumination pattern of FIG. 12, using a bandpass filter, which limits the maximum frequency of the image, generated by filtering the image shown in FIG. 12, to reduce the upper frequency content of the image, based on an upper cutoff frequency, F5, of the bandpass filter, used to filter the image of FIG. 12, where F5<F6.

FIG. 15 shows a third medium resolution filtered illumination pattern, e.g., a grayscale image pattern, generated by filtering the illumination pattern of FIG. 12, using a bandpass filter, which limits the maximum frequency of the image, generated by filtering the image shown in FIG. 12, to reduce the upper frequency content of the image, based on an upper cutoff frequency, F4, of the bandpass filter, used to filter the image of FIG. 12, where F4<F5<F6.

FIG. 16 shows an unfiltered exemplary high resolution illumination pattern, e.g., a black and white illumination pattern.

FIG. 17 shows a first high resolution filtered illumination pattern, e.g., a grayscale image pattern, generated by filtering the illumination pattern of FIG. 16, using a bandpass filter, which limits the maximum frequency of the image, generated by filtering the image shown in FIG. 16, to reduce the upper frequency content of the image, based on an upper cutoff frequency, F9, of the bandpass filter, used to filter the image of FIG. 16.

FIG. 18 shows a second high resolution filtered illumination pattern, e.g., a grayscale image pattern, generated by filtering the illumination pattern of FIG. 16, using a bandpass filter, which limits the maximum frequency of the image, generated by filtering the image shown in FIG. 16, to reduce the upper frequency content of the image, based on an upper cutoff frequency, F8, of the bandpass filter, used to filter the image of FIG. 16, where F8<F9.

FIG. 19 shows a third low resolution filtered illumination pattern, e.g., a grayscale image pattern, generated by filtering the illumination pattern of FIG. 16, using a bandpass filter, which limits the maximum frequency of the image, generated by filtering the image shown in FIG. 16, to reduce the upper frequency content of the image, based on an upper cutoff frequency, F7, of the bandpass filter, used to filter the image of FIG. 16 where F7<F8<F9.

As part of a stereoscopic depth determination operation, cameras in a camera array 112 capture images of the illumination pattern. Portions of one captured image are matched to find the location in another captured image and the disparity, e.g., change in location of where an object or portion of an object appears in two images is used to determine a distance from a camera to the object.

The random or pseudo random nature of the illumination pattern is intentional and intended to reduce the risk of a recurring pattern in the illumination images which might result in erroneous matches of different objects or image portions captured by different cameras due the recurring nature of the image pattern being captured.

While random patterns have certain advantages for stereoscopic depth determination purposes, they often include high frequency content which exceeds the capture capability of the cameras in the array which often having a sampling rate below the Nyquist rate of the random images of pixels being used for illumination purposes. This often leads to captured images suffering from aliasing.

For purposes of determining the disparity it is sometimes useful to perform sub-pixel interpolation. In the case of random patterns with binary pixel values, high frequency content may be lost when the images of a random pattern are captured by cameras of a stereoscopic pair. Due to the loss of high frequency information during image capture, errors may be introduced into one or more captured images. This results in aliasing which will often result in slight differences in images captured by different cameras in an array. Aliasing makes accurate pattern matching somewhat unreliable particularly if sub-pixel interpolation is used as part of the pattern matching or disparity determination process.

In view of the above discussion, it should be appreciated if methods and/or apparatus could be developed which would allow a stereoscopic depth determination system to take advantage of benefits of using a random or pseudo random illumination pattern while avoiding the effect of aliasing.

In various embodiments a bandlimited illumination pattern is used for illumination patterns. The bandlimited illumination pattern is generated in some embodiments by using a bandpass filter to filter an illumination pattern to limit the frequencies to a band having a predetermined maximum frequency. By filtering the same image using bandpass filters with different upper cut off frequencies, different illumination images can be and sometimes are generated. The images are stored for possible use as illumination images/patterns which can be selected for projection to illuminate a scene area including one or more objects.

By using a bandwidth limited illumination pattern, matched to cameras with a known sampling rate that is high enough rate the original pattern can be accurately reconstructed from the finite set of samples captured by the cameras of the digital array aliasing and/or other distortions in captured images used for stereoscopic depth determinations can be avoided, minimized and/or kept to within acceptable limits. The illumination pattern can be random or pseudo random in nature, with the projected image being visible light, non-visible light, color and/or grayscale depending on the particular embodiment but with the frequency content being constrained, e.g., by the selection of an appropriate band limited image for a given illumination application and/or distance, to avoid the undesired effects of aliasing, This is because camera capabilities are taken into consideration when constructing the illumination pattern to be used in a given stereoscopic depth determination system and/or selecting of a stored illumination pattern, e.g., image, for illumination purposes.

The use of one or more intentionally bandwidth limited illumination patterns with cameras of a stereoscopic camera pair capable of accurately capturing the bandwidth limited illumination images with little or no aliasing facilitates stereoscopic depth determinations and sub-pixel interpolation operations associated with some such depth determinations.

In at least some embodiments a random image or pseudo rand image is generated for illumination purposes and then bandpass filtered to produce one but in many cases multiple illumination image patterns that are bandwidth limited with different images being filtered to be bandwidth limited to different frequency ranges. An image which is limited to frequencies in or below a maximum frequency which is within the frequency capture range of the cameras of the stereoscopic camera array being used to illuminate a scene area is selected and used with the illumination image being dynamically selected in some embodiments taking into consideration one or more factors, such as distance from the illumination device to the area that is illuminated, that can affect the ability of the cameras to accurate capture the image details/full range of frequency content in the image.

The illumination pattern selected to be used at a given time, e.g., based on the expected or know distance to the object(s) to be illuminated is projected and captured by the cameras of the array.

Stereoscopic depth determinations are then made based on captured images of the illumination pattern free from aliasing that often occurs in systems which do not use such a bandwidth constrained illumination pattern that is paired to/used in combination with cameras capable of capturing the illumination pattern image in a reliable manner because the maximum frequencies of the illumination image are withing the frequency capture capabilities of the cameras being used.

Various exemplary numbered embodiments will now be discussed. In each of the following lists of numbered embodiments a reference to a preceding numbered embodiment refers to an embodiment in the same list.

### First List of Exemplary Numbered Method Embodiments

Numbered Method Embodiment 1. A depth determination method, the method comprising: selecting (740), based on at least one of: i) a camera to surface distance (CTOSD), ii) a projector to object surface distance (PTOSD), or iii) both a CTOSD and PTOSD, an illumination pattern (any one of patterns/illumination images 800, 900,1000, 1100, 1200, 1300, 1400, 1500, 1600, 1700, 1800, 1900) to use; projecting (758) the selected illumination pattern on a surface (e.g., front surface 406 of object 140); operating (760) cameras including a first camera (114) and a second camera (116) to capture images of said illumination pattern on said surface, said images including a first image captured by the first camera (114) and a second image captured by the second camera (116); and performing (762), using said first and second images, a stereoscopic depth determination, said stereoscopic depth determination determining a depth to said surface (406).

Numbered Method Embodiment 2. The depth determination method of Numbered Method Embodiment 1, wherein said selected illumination pattern is a first bandlimited illumination pattern (e.g. one of the image patterns 900, 1000, 1100, 1300, 1400, 1500, 1700, 1800 or 1900 generated by low pass filtering an image pattern to limit the frequency content of the bandlimited illumination pattern)

Numbered Method Embodiment 2A. The method of Numbered Method Embodiment 2, wherein the bandlimited illumination pattern is bandlimited in frequency content to a frequency band having a maximum frequency less than ½ a maximum sampling frequency (e.g., Nyquist frequency) of the first and second cameras (114, 116) when the first and second cameras (114, 116) are used to capture the images of the illumination pattern on said surface.

Numbered Method Embodiment 2B. The method of Numbered Method Embodiment 2A, wherein said maximum sampling frequency is a maximum sampling frequency (fm) corresponding to when the first and second cameras are at a first distance (e.g., CTOSD1) from said surface.

Numbered Method Embodiment 3. The depth determination method of Numbered Method Embodiment 1, wherein performing (762) a stereoscopic depth determination includes performing a sub-pixel interpolation operation (763) and estimating (764) a depth between a sub-pixel disparity determined based on the results of said sub-pixel interpolation operation.

Numbered Method Embodiment 4. The method of Numbered Method Embodiment 2, further comprising: performing (722) a low pass filtering operation on a first illumination pattern (800) to generate said first bandwidth limited illumination pattern (e.g., 900).

Numbered Method Embodiment 5. The method of Numbered Method Embodiment 4, wherein said bandpass filtering (722) limits frequencies included in said first bandwidth limited illumination pattern to frequencies equal to or below ½ a first maximum sampling frequency (Nyquist frequency) (e.g., to a frequency below ½ the first maximum sampling frequency by 10%, 20% or 30% of the maximum sampling frequency (e.g., Nyquist frequency of the cameras) in some embodiments to have a safety margin) corresponding to a first camera to surface distance (CTOSD) (e.g., CTOSD1) (where the first maximum frequency is a Nyquist sampling frequency supported by the first and second cameras when at the first CTOSD (CTOSD′), said first and second cameras being capable of capturing the first bandwidth limited image without suffering aliasing when at the first CTOSD).

Numbered Method Embodiment 6. The method of Numbered Method Embodiment 4, further comprising: performing (724) a second low pass filtering operation on a second illumination pattern (1200) to generate a second bandwidth limited illumination pattern (1300).

Numbered Method Embodiment 7. The method of Numbered Method Embodiment 6, wherein said lowpass filtering (224) limits frequencies included in a second bandwidth limited illumination pattern (1300) to frequencies equal to or below ½ a second maximum frequency corresponding to a second CTOSD (e.g., CTOSD2) (e.g., to a frequency below ½ the second maximum frequency by 10%, 20% or 30% of the maximum sampling frequency in some embodiments to have a safety margin).

Numbered Method Embodiment 7A. The method of Numbered Method Embodiment 6, wherein said second bandwidth illumination pattern has a higher spatial resolution than said first bandwidth limited illumination pattern.

Numbered Method Embodiment 8. The method of Numbered Method Embodiment 3, further comprising: performing (726) a third low pass filtering on a third illumination pattern (1600) to generate a third bandwidth limited illumination pattern (1700).

Numbered Method Embodiment 9. The method of Numbered Method Embodiment 8, wherein said third bandpass filtering (726) limits frequencies included in said third bandwidth limited illumination pattern (1700) to frequencies equal to or below ½ a maximum sampling frequency corresponding to a third CTOSD (CTOSD3).

Numbered Method Embodiment 10. The method of Numbered Method Embodiment 9, wherein said third bandwidth limited illumination pattern (1700) is has a higher spatial resolution than said first bandwidth limited illumination pattern (900) or second bandwidth limited illumination pattern (1200).

Numbered Method Embodiment 11. The method of Numbered Method Embodiment 1, wherein selecting (740), based on at least one of: i) a camera to surface distance (CTOSD), ii) a projector to object surface distance (PTOSD), or iii) both a CTOSD and PTOSD includes: selecting said first bandwidth limited illumination pattern based on a ratio determined from the CTOSD and PTOSD.

Numbered Method Embodiment 12. The method of Numbered Method Embodiment 1, wherein said ratio determined from the CTOSD and PTOSD is a PSTOD:CTOSD ratio; and wherein said selecting includes selecting a bandwidth limited illumination pattern having a first maximum frequency when the PTOSD:CTOSD ratio is a first value and selecting another bandwidth limited illumination pattern when the PTOSD:CTOSD is a second value.

Numbered Method Embodiment 13. The method of Numbered Method Embodiment 12, wherein the first value is higher than said second value; and the first maximum frequency is higher than said second maximum frequency, said bandwidth limited illumination pattern having the first maximum frequency being selected when the PTOSD:CTOSD is the higher first value than when it is the lower second value (e.g., a higher PTOSD:CTOSD ratio results in a higher frequency content bandwidth limited image being selected for use as the illumination image than when the PTOSD:CTOSD is lower).

Numbered Method Embodiment 14. The method of Numbered Method Embodiment 1, wherein selecting (740), based on at least one of: i) a camera to surface distance (CTOSD), ii) a projector to object surface distance (PTOSD), or iii) both a CTOSD and PTOSD, an illumination pattern (any one of patterns/illumination images 800, 900,1000, 1100, 1200, 1300, 1400, 1500, 1600, 1700, 1800, 1900) to use includes: selecting, based on the CTOSD, as the first illumination pattern, a bandwidth limited illumination (900) having a first resolution when the CTOSD is within a first distance range; and selecting, based on the CTOSD, as the first illumination pattern, a bandwidth limited illumination pattern (1300) having a second resolution when the CTOSD is within a second distance range, said second distance range including smaller distances than said first distance range, second resolution being higher than said first resolution (e.g., a higher frequency content pattern image and/or higher resolution pattern image is selected when the camera are closer to the object to be measured than when the cameras are further away from the object to be measured).

Numbered Method Embodiment 15. The method of Numbered Method Embodiment 1, wherein selecting (740), based on at least one of: i) a camera to surface distance (CTOSD), ii) a projector to object surface distance (PTOSD), or iii) both a CTOSD and PTOSD, an illumination pattern (any one of patterns/illumination images 800, 900,1000, 1100, 1200, 1300, 1400, 1500, 1600, 1700, 1800, 1900) to use includes: selecting, based on the CTOSD, as the first illumination pattern, a bandwidth limited illumination (900) having a first maximum frequency when the CTOSD is within a first distance range; and selecting, based on the CTOSD, as the first illumination pattern, a bandwidth limited illumination pattern (1300) having a second maximum frequency when the CTOSD is within a second distance range, said second distance range including smaller distances than said first distance range, the second maximum frequency being higher than said first maximum frequency (e.g., a higher frequency content pattern image is selected when the cameras are closer to the object to be measured than is selected when the cameras are further away from the object to be measured thus a high or medium frequency content pattern image will be selected as the illumination image when the CTSOD is a small distance and a low frequency content pattern image will be selected when the CTOSD in a large distance).

Numbered Method Embodiment 16. The method of Numbered Method Embodiment 1, wherein selecting (740), based on at least one of: i) a camera to surface distance (CTOSD), ii) a projector to object surface distance (PTOSD), or iii) both a CTOSD and PTOSD, an illumination pattern (any one of patterns/illumination images 800, 900,1000, 1100, 1200, 1300, 1400, 1500, 1600, 1700, 1800, 1900) to use includes: selecting, based on the PTOSD, as the first illumination pattern, a bandwidth limited illumination pattern (1300) having a second maximum frequency (e.g., high frequency and/or high resolution illumination pattern) when the PTOSD is within a first distance range (e.g., a far away distance range from the object being measured); and selecting, based on the PTOSD, as the first illumination pattern, a bandwidth limited illumination pattern (900) having a first maximum frequency (e.g., low maximum frequency) when the PTOSD is within a second distance range (e.g., a near to object being measured distance range), said second distance range including smaller distances than said first distance range, the first maximum frequency being lower than said second maximum frequency (e.g., a higher frequency content pattern image is selected when the illumination projector 108 is further way from the object being measured than when the illumination projector 108 is close to the object being measured since the projected image will appear larger on the illuminated surface when the projector is far away than when it is near the surface).

### First List of Exemplary Numbered Apparatus Embodiments

Numbered Apparatus Embodiment 1. An apparatus comprising: a light projector; memory storing a digital representation of a first illumination pattern; a processor configured to: select (740), based on at least one of: i) a camera to surface distance (CTOSD), ii) a projector to object surface distance (PTOSD), or iii) both a CTOSD and PTOSD, an illumination pattern (any one of patterns/illumination images 800, 900,1000, 1100, 1200, 1300, 1400, 1500, 1600, 1700, 1800, 1900) to use; project (758) the selected illumination pattern on a surface (e.g., front surface 406 of object 140); operate (760) cameras including a first camera (114) and a second camera (116) to capture images of said illumination pattern on said surface, said images including a first image captured by the first camera (114) and a second image captured by the second camera (116); and perform (762), using said first and second images, a stereoscopic depth determination, said stereoscopic depth determination determining a depth to said surface (406).

Numbered Apparatus Embodiment 2. The apparatus of Numbered Apparatus Embodiment 1, wherein said selected illumination pattern is a first bandlimited illumination pattern (e.g. one of the image patterns 900, 1000, 1100, 1300, 1400, 1500, 1700, 1800 or 1900 generated by low pass filtering an image pattern to limit the frequency content of the bandlimited illumination pattern).

Numbered Apparatus Embodiment 2A. The apparatus of Numbered Apparatus Embodiment 2, wherein the bandlimited illumination pattern is bandlimited in frequency content to a frequency band having a maximum frequency less than ½ a maximum sampling frequency (e.g., Nyquist frequency) of the first and second cameras (114, 116) when the first and second cameras (114, 116) are used to capture the images of the illumination pattern on said surface.

Numbered Apparatus Embodiment 2B. The apparatus of Numbered Apparatus Embodiment 2A, wherein said maximum sampling frequency is a maximum sampling frequency (fm) corresponding to when the first and second cameras are at a first distance (e.g., CTOSD1) from said surface.

Numbered Apparatus Embodiment 3. The apparatus of Numbered Apparatus Embodiment 1, wherein the processor is configured, as part of being configured to perform (762) a stereoscopic depth determination, to: perform a sub-pixel interpolation operation (763); and estimate (764) a depth between a sub-pixel disparity determined based on the results of said sub-pixel interpolation operation

Numbered Apparatus Embodiment 4. The apparatus of Numbered Apparatus Embodiment 2, wherein the processor is further configured to: perform (722) a low pass filtering operation on a first illumination pattern (800) to generate said first bandwidth limited illumination pattern (e.g., 900).

Numbered Apparatus Embodiment 5. The apparatus of Numbered Apparatus Embodiment 4, wherein said bandpass filtering (722) limits frequencies included in said first bandwidth limited illumination pattern to frequencies equal to or below ½ a first maximum sampling frequency (Nyquist frequency) (e.g., to a frequency below ½ the first maximum sampling frequency by 10%, 20% or 30% of the maximum sampling frequency (e.g., Nyquist frequency of the cameras) in some embodiments to have a safety margin) corresponding to a first camera to surface distance (CTOSD) (e.g., CTOSD1) (where the first maximum frequency is a Nyquist sampling frequency supported by the first and second cameras when at the first CTOSD (CTOSD′), said first and second cameras being capable of capturing the first bandwidth limited image without suffering aliasing when at the first CTOSD).

Numbered Apparatus Embodiment 6. The apparatus of Numbered Apparatus Embodiment 4, wherein the processor is further configured to: perform (724) a second low pass filtering operation on a second illumination pattern (1200) to generate a second bandwidth limited illumination pattern (1300).

Numbered Apparatus Embodiment 7. The apparatus of Numbered Apparatus Embodiment 6, wherein said lowpass filtering (224) limits frequencies included in a second bandwidth limited illumination pattern (1300) to frequencies equal to or below ½ a second maximum frequency corresponding to a second CTOSD (e.g., CTOSD2) (e.g., to a frequency below ½ the second maximum frequency by 10%, 20% or 30% of the maximum sampling frequency in some embodiments to have a safety margin).

Numbered Apparatus Embodiment 7A. The apparatus of Numbered Apparatus Embodiment 6, wherein said second bandwidth illumination pattern has a higher spatial resolution than said first bandwidth limited illumination pattern.

Numbered Apparatus Embodiment 8. The apparatus of Numbered Apparatus Embodiment 3, wherein the processor is further configured to: perform (726) a third low pass filtering on a third illumination pattern (1600) to generate a third bandwidth limited illumination pattern (1700).

Numbered Apparatus Embodiment 9. The apparatus of Numbered Apparatus Embodiment 8, wherein said third bandpass filtering (726) limits frequencies included in said third bandwidth limited illumination pattern (1700) to frequencies equal to or below ½ a maximum sampling frequency corresponding to a third CTOSD (CTOSD3).

Numbered Apparatus Embodiment 10. The apparatus of Numbered Apparatus Embodiment 9, wherein said third bandwidth limited illumination pattern (1700) is has a higher spatial resolution than said first bandwidth limited illumination pattern (900) or second bandwidth limited illumination pattern (1200).

Numbered Apparatus Embodiment 11. The apparatus of Numbered Apparatus Embodiment 1, wherein selecting (740), based on at least one of: i) a camera to surface distance (CTOSD), ii) a projector to object surface distance (PTOSD), or iii) both a CTOSD and PTOSD includes: selecting said first bandwidth limited illumination pattern based on a ratio determined from the CTOSD and PTOSD.

Numbered Apparatus Embodiment 12. The apparatus of Numbered Apparatus Embodiment 1, wherein said ratio determined from the CTOSD and PTOSD is a PSTOD:CTOSD ratio; and wherein said selecting includes selecting a bandwidth limited illumination pattern having a first maximum frequency when the PTOSD:CTOSD ratio is a first value and selecting another bandwidth limited illumination pattern when the PTOSD:CTOSD is a second value.

Numbered Apparatus Embodiment 13. The apparatus of Numbered Apparatus Embodiment 12, wherein the first value is higher than said second value; and the first maximum frequency is higher than said second maximum frequency, said bandwidth limited illumination pattern having the first maximum frequency being selected when the PTOSD:CTOSD is the higher first value than when it is the lower second value (e.g., a higher PTOSD:CTOSD ratio results in a higher frequency content bandwidth limited image being selected for use as the illumination image than when the PTOSD:CTOSD is lower).

Numbered Apparatus Embodiment 14. The apparatus of Numbered Apparatus Embodiment 1, wherein the processor is configured, as part of being configured to select (740), based on at least one of: i) a camera to surface distance (CTOSD), ii) a projector to object surface distance (PTOSD), or iii) both a CTOSD and PTOSD, an illumination pattern (any one of patterns/illumination images 800, 900,1000, 1100, 1200, 1300, 1400, 1500, 1600, 1700, 1800, 1900) to: select, based on the CTOSD, as the first illumination pattern, a bandwidth limited illumination (900) having a first resolution when the CTOSD is within a first distance range; and select, based on the CTOSD, as the first illumination pattern, a bandwidth limited illumination pattern (1300) having a second resolution when the CTOSD is within a second distance range, said second distance range including smaller distances than said first distance range, second resolution being higher than said first resolution (e.g., a higher frequency content pattern image and/or higher resolution pattern image is selected when the camera are closer to the object to be measured than when the cameras are further away from the object to be measured).

Numbered Apparatus Embodiment 15. The apparatus of Numbered Apparatus Embodiment 1, wherein the processor is configured, as part of being configured to select (740), based on at least one of: i) a camera to surface distance (CTOSD), ii) a projector to object surface distance (PTOSD), or iii) both a CTOSD and PTOSD, an illumination pattern (any one of patterns/illumination images 800, 900,1000, 1100, 1200, 1300, 1400, 1500, 1600, 1700, 1800, 1900) to use: select, based on the CTOSD, as the first illumination pattern, a bandwidth limited illumination (900) having a first maximum frequency when the CTOSD is within a first distance range; and select, based on the CTOSD, as the first illumination pattern, a bandwidth limited illumination pattern (1300) having a second maximum frequency when the CTOSD is within a second distance range, said second distance range including smaller distances than said first distance range, the second maximum frequency being higher than said first maximum frequency (e.g., a higher frequency content pattern image is selected when the cameras are closer to the object to be measured than is selected when the cameras are further away from the object to be measured thus a high or medium frequency content pattern image will be selected as the illumination image when the CTSOD is a small distance and a low frequency content pattern image will be selected when the CTOSD in a large distance).

Numbered Apparatus Embodiment 16. The apparatus of Numbered Apparatus Embodiment 1, wherein the processor, as part of being configured to select (740), based on at least one of: i) a camera to surface distance (CTOSD), ii) a projector to object surface distance (PTOSD), or iii) both a CTOSD and PTOSD, an illumination pattern (any one of patterns/illumination images 800, 900,1000, 1100, 1200, 1300, 1400, 1500, 1600, 1700, 1800, 1900) to: select, based on the PTOSD, as the first illumination pattern, a bandwidth limited illumination pattern (1300) having a second maximum frequency (e.g., high frequency and/or high resolution illumination pattern) when the PTOSD is within a first distance range (e.g., a far away distance range from the object being measured); and select, based on the PTOSD, as the first illumination pattern, a bandwidth limited illumination pattern (900) having a first maximum frequency (e.g., low maximum frequency) when the PTOSD is within a second distance range (e.g., a near to object being measured distance range), said second distance range including smaller distances than said first distance range, the first maximum frequency being lower than said second maximum frequency (e.g., a higher frequency content pattern image is selected when the illumination projector 108 is further way from the object being measured than when the illumination projector 108 is close to the object being measured since the projected image will appear larger on the illuminated surface when the projector is far away than when it is near the surface).

### First List of Exemplary Numbered

### Non-Transitory Machine Readable Embodiments

1. A non-transitory machine readable medium (204) including processor executable instructions which when executed by a processor 202 cause the processor to control the apparatus to: select (740), based on at least one of: i) a camera to surface distance (CTOSD), ii) a projector to object surface distance (PTOSD), or iii) both a CTOSD and PTOSD, an illumination pattern (any one of patterns/illumination images 800, 900,1000, 1100, 1200, 1300, 1400, 1500, 1600, 1700, 1800, 1900) to use; project (758) the selected illumination pattern on a surface (e.g., front surface 406 of object 140); operate (760) cameras including a first camera (114) and a second camera (116) to capture images of said illumination pattern on said surface, said images including a first image captured by the first camera (114) and a second image captured by the second camera (116); and perform (762), using said first and second images, a stereoscopic depth determination, said stereoscopic depth determination determining a depth to said surface (406)

### Second List of Exemplary Numbered Method Embodiments

Numbered Method Embodiment 1. A depth determination method, the method comprising: projecting (758) a first band limited illumination pattern (900) onto a surface (406) of an object 140, said first band limited illumination pattern (900) having been generated by lowpass filtering a first image (800) to generate said first band limited illumination pattern (900); operating a pair (403) of cameras (114, 116) to capture images of said first band limited illumination pattern (900), said pair of cameras (114, 116) including a first camera (114) that captures a first image of the illuminated surface and a second camera (116) that captures a second image of the illuminated surface; and performing (762), using said first and second images, a stereoscopic depth determination, said stereoscopic depth determination determining a depth to said surface (406).

Numbered Method Embodiment 2. The method of Numbered Method Embodiment 1, wherein the first bandlimited illumination pattern (900) has a maximum a baseband component that occupies less than 90 percent of the Nyquist bandwidth of the first band limited illumination pattern when projected onto said surface.

Numbered Method Embodiment 3. The method of Numbered Method Embodiment 2, wherein the digital image is a digital signal in the form of pixel values representing the first image (800), said pixel values corresponding to one or more discrete points in time and being quantized to discrete levels.

Numbered Method Embodiment 4. The method of claim 1, wherein the first bandlimited illumination pattern (900) is a first grayscale image pattern generated by low pass filtering the digital signal representing the first illumination pattern.

Numbered Method Embodiment 5. The method of Numbered Method Embodiment 1, wherein the first band limited illumination pattern (900) is a binary image pattern (e.g., black/white image pattern).

Numbered Method Embodiment 6. The method of Numbered Method Embodiment 1, wherein a baseband signal component of the band limited illumination pattern (900) has a maximum frequency, Fm, of X Hz; wherein each of the first and second cameras has a sampling frequency exceeding at least twice the maximum frequency of X Hz; and where X is a non-zero positive number.

### Second List of Exemplary Numbered Apparatus Embodiments

Numbered Apparatus Embodiment 1. An apparatus (104), comprising: light projector (108) for projecting an illumination pattern; a pair (403) of cameras including a first camera (114) and a second camera (116); and a processor (202) configured to: control the light projector (108) to project (758) a first band limited illumination pattern (900) onto a surface (406) of an object 140, said first band limited illumination pattern (900) having been generated by lowpass filtering a first image (800) to generate said first band limited illumination pattern (900); operating the pair (403) of cameras (114, 116) to capture images of said first band limited illumination pattern (900), said pair of cameras (114, 116) including the first camera (114) that captures a first image of the illuminated surface and the second camera (116) that captures a second image of the illuminated surface; and perform (762), using said first and second images, a stereoscopic depth determination, said stereoscopic depth determination determining a depth to said surface (406).

Numbered Apparatus Embodiment 2. The apparatus of Numbered Apparatus Embodiment 1, wherein the first bandlimited illumination pattern (900) has a maximum a baseband component that occupies less than 90 percent of the Nyquist bandwidth of the first band limited illumination pattern when projected onto said surface.

Numbered Apparatus Embodiment 3. The apparatus of Numbered Apparatus Embodiment 2, wherein the digital image is a digital signal in the form of pixel values representing the first image (800), said pixel values corresponding to one or more discrete points in time and being quantized to discrete levels.

Numbered Apparatus Embodiment 4. The apparatus of Numbered Apparatus Embodiment 1, wherein the first bandlimited illumination pattern (900) is a first grayscale image pattern generated by low pass filtering the digital signal representing the first illumination pattern.

Numbered Apparatus Embodiment 5. The apparatus of Numbered Apparatus Embodiment 1, wherein the first band limited illumination pattern (900) is a binary image pattern (e.g., black/white image pattern).

Numbered Apparatus Embodiment 6. The apparatus of Numbered Apparatus Embodiment 1, wherein a baseband signal component of the band limited illumination pattern (900) has a maximum frequency, Fm, of X Hz; wherein each of the first and second cameras has a sampling frequency exceeding at least twice the maximum frequency of X Hz; and where X is a non-zero positive number.

### Second List of Exemplary Numbered

### Non-Transitory Machine Readable Embodiments

1. A non-transitory machine readable medium (204) including processor executable instructions which when executed by a processor 202 cause the processor to control the apparatus to: control a light projector (108) to project (758) a first band limited illumination pattern (900) onto a surface (406) of an object 140, said first band limited illumination pattern (900) having been generated by lowpass filtering a first image (800) to generate said first band limited illumination pattern (900); operate a pair (403) of cameras (114, 116) to capture images of said first band limited illumination pattern (900), said pair of cameras (114, 116) including the first camera (114) that captures a first image of the illuminated surface and the second camera (116) that captures a second image of the illuminated surface; and perform (762), using said first and second images, a stereoscopic depth determination, said stereoscopic depth determination determining a depth to said surface (406).

Some aspects and/or features are directed a non-transitory computer readable medium embodying a set of software instructions, e.g., computer executable instructions, for controlling a computer or other device, e.g., a vehicle or robotic device, to operate in accordance with the above discussed methods.

The techniques of various embodiments may be implemented using software, hardware and/or a combination of software and hardware. Various embodiments are directed to a control apparatus, e.g., controller or control system, which can be implemented using a microprocessor including a CPU, memory and one or more stored instructions for controlling a device or apparatus to implement one or more of the above described steps. Various embodiments are also directed to methods, e.g., a method of controlling a vehicle or drone or remote control station and/or performing one or more of the other operations described in the present application. Various embodiments are also directed to a non-transitory machine, e.g., computer, readable medium, e.g., ROM, RAM, CDs, hard discs, etc., which include machine readable instructions for controlling a machine to implement one or more steps of a method.

As discussed above, various features of the present invention are implemented using modules and/or components. Such modules and/or components may, and in some embodiments are, implemented as software modules and/or software components. In other embodiments the modules and/or components are implemented in hardware. In still other embodiments the modules and/or components are implemented using a combination of software and hardware. In some embodiments the modules and/or components are implemented as individual circuits with each module and/or component being implemented as a circuit for performing the function to which the module and/or component corresponds. A wide variety of embodiments are contemplated including some embodiments where different modules and/or components are implemented differently, e.g., some in hardware, some in software, and some using a combination of hardware and software. It should also be noted that routines and/or subroutines, or some of the steps performed by such routines, may be implemented in dedicated hardware as opposed to software executed on a general purpose processor. Such embodiments remain within the scope of the present invention. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods. Accordingly, among other things, the present invention is directed to a machine-readable medium including machine executable instructions for causing a machine, e.g., processor and associated hardware, to perform one or more of the steps of the above-described method(s).

The techniques of the present invention may be implemented using software, hardware and/or a combination of software and hardware. The present invention is directed to apparatus, e.g., a vehicle which implements one or more of the steps of the present invention. The present invention is also directed to machine readable medium, e.g., ROM, RAM, CDs, hard discs, etc., which include machine readable instructions for controlling a machine to implement one or more steps in accordance with the present invention.

Numerous additional variations on the methods and apparatus of the various embodiments described above will be apparent to those skilled in the art in view of the above description. Such variations are to be considered within the scope.

What is claimed is:

1. A depth determination method, the method comprising:
selecting, based on at least one of: i) a camera to surface distance (CTOSD), ii) a projector to object surface distance (PTOSD), or iii) both a CTOSD and PTOSD, an illumination pattern to use;
projecting the selected illumination pattern on a surface;
operating cameras including a first camera and a second camera to capture images of said illumination pattern on said surface, said images including a first image captured by the first camera and a second image captured by the second camera; and
performing, using said first and second images, a stereoscopic depth determination, said stereoscopic depth determination determining a depth to said surface.

2. The depth determination method of claim 1, wherein said selected illumination pattern is a first bandlimited illumination pattern.

3. The depth determination method of claim 1, wherein performing a stereoscopic depth determination includes performing a sub-pixel interpolation operation and estimating a depth between a sub-pixel disparity determined based on the results of said sub-pixel interpolation operation.

4. The method of claim 2, further comprising:
performing a low pass filtering operation on a first illumination pattern to generate said first bandwidth limited illumination pattern.

5. The method of claim 4, wherein said bandpass filtering limits frequencies included in said first bandwidth limited illumination pattern to frequencies equal to or below ½ a first maximum sampling frequency corresponding to a first camera to surface distance (CTOSD).

6. The method of claim 4, further comprising:
performing a second low pass filtering operation on a second illumination pattern to generate a second bandwidth limited illumination pattern.

7. The method of claim 6, wherein said lowpass filtering limits frequencies included in a second bandwidth limited illumination pattern to frequencies equal to or below ½ a second maximum frequency corresponding to a second CTOSD.

8. The method of claim 1, wherein selecting, based on at least one of: i) a camera to surface distance (CTOSD), ii) a projector to object surface distance (PTOSD), or iii) both a CTOSD and PTOSD includes:
selecting said first bandwidth limited illumination pattern based on a ratio determined from the CTOSD and PTOSD.

9. The method of claim 1,
wherein said ratio determined from the CTOSD and PTOSD is a PSTOD:CTOSD ratio; and
wherein said selecting includes selecting a bandwidth limited illumination pattern having a first maximum frequency when the PTOSD:CTOSD ratio is a first value and selecting another bandwidth limited illumination pattern when the PTOSD:CTOSD is a second value.

10. The method of claim 9,
wherein the first value is higher than said second value; and
the first maximum frequency is higher than said second maximum frequency, said bandwidth limited illumination pattern having the first maximum frequency being selected when the PTOSD:CTOSD is the higher first value than when it is the lower second value.

11. The method of claim 1, wherein selecting, based on at least one of: i) a camera to surface distance (CTOSD), ii) a projector to object surface distance (PTOSD), or iii) both a CTOSD and PTOSD, an illumination pattern to use includes:
selecting, based on the CTOSD, as the first illumination pattern, a bandwidth limited illumination having a first resolution when the CTOSD is within a first distance range; and
selecting, based on the CTOSD, as the first illumination pattern, a bandwidth limited illumination pattern having a second resolution when the CTOSD is within a second distance range, said second distance range including smaller distances than said first distance range, second resolution being higher than said first resolution.

12. The method of claim 1, wherein selecting, based on at least one of: i) a camera to surface distance (CTOSD), ii) a projector to object surface distance (PTOSD), or iii) both a CTOSD and PTOSD, an illumination pattern to use includes:
selecting, based on the CTOSD, as the first illumination pattern, a bandwidth limited illumination having a first maximum frequency when the CTOSD is within a first distance range; and
selecting, based on the CTOSD, as the first illumination pattern, a bandwidth limited illumination pattern having a second maximum frequency when the CTOSD is within a second distance range, said second distance range including smaller distances than said first distance range, the second maximum frequency being higher than said first maximum frequency.

13. The method of claim 1, wherein selecting, based on at least one of: i) a camera to surface distance (CTOSD), ii) a projector to object surface distance (PTOSD), or iii) both a CTOSD and PTOSD, an illumination pattern to use includes:
selecting, based on the PTOSD, as the first illumination pattern, a bandwidth limited illumination pattern having a second maximum frequency when the PTOSD is within a first distance range; and
selecting, based on the PTOSD, as the first illumination pattern, a bandwidth limited illumination pattern having a first maximum frequency when the PTOSD is within a second distance range, said second distance range including smaller distances than said first distance range, the first maximum frequency being lower than said second maximum frequency.

14. An apparatus comprising:
a light projector;
memory storing a digital representation of a first illumination pattern;
a processor configured to:
select, based on at least one of: i) a camera to surface distance (CTOSD), ii) a projector to object surface distance (PTOSD), or iii) both a CTOSD and PTOSD, an illumination pattern to use;
project the selected illumination pattern on a surface;
operate cameras including a first camera and a second camera to capture images of said illumination pattern on said surface, said images including a first image captured by the first camera and a second image captured by the second camera; and
perform, using said first and second images, a stereoscopic depth determination, said stereoscopic depth determination determining a depth to said surface.

15. The apparatus of claim 14, wherein said selected illumination pattern is a first bandlimited illumination pattern.

16. The apparatus of claim 14, wherein the processor is configured, as part of being configured to perform a stereoscopic depth determination, to:
perform a sub-pixel interpolation operation; and
estimate a depth between a sub-pixel disparity determined based on the results of said sub-pixel interpolation operation.

17. The apparatus of claim 15, wherein the processor is further configured to:
perform a low pass filtering operation on a first illumination pattern to generate said first bandwidth limited illumination pattern.

18. A depth determination method, the method comprising:
projecting a first band limited illumination pattern onto a surface of an object, said first band limited illumination pattern having been generated by lowpass filtering a first image to generate said first band limited illumination pattern;
operating a pair of cameras to capture images of said first band limited illumination pattern, said pair of cameras including a first camera that captures a first image of the illuminated surface and a second camera that captures a second image of the illuminated surface; and
performing, using said first and second images, a stereoscopic depth determination, said stereoscopic depth determination determining a depth to said surface.

19. The method of claim 18, wherein the first bandlimited illumination pattern has a maximum baseband component that occupies less than 90 percent of the Nyquist bandwidth of the first band limited illumination pattern when projected onto said surface.

20. The method of claim 19, wherein the digital image is a digital signal in the form of pixel values representing the first image, said pixel values corresponding to one or more discrete points in time and being quantized to discrete levels.

21. The method of claim 18, wherein the first bandlimited illumination pattern is a first grayscale image pattern generated by low pass filtering the digital signal representing the first illumination pattern.

22. The method of claim 18, wherein the first band limited illumination pattern is a binary image pattern.

23. The method of claim 18, wherein a baseband signal component of the band limited illumination pattern has a maximum frequency, Fm, of X Hz;
wherein each of the first and second cameras has a sampling frequency exceeding at least twice the maximum frequency of X Hz; and
where X is a non-zero positive number.

24. An apparatus, comprising:
light projector for projecting an illumination pattern;
a pair of cameras including a first camera and a second camera; and
a processor configured to:
control the light projector to project a first band limited illumination pattern onto a surface of an object 140, said first band limited illumination pattern having been generated by lowpass filtering a first image to generate said first band limited illumination pattern;
operating the pair of cameras to capture images of said first band limited illumination pattern, said pair of cameras including the first camera that captures a first image of the illuminated surface and the second camera that captures a second image of the illuminated surface; and
perform, using said first and second images, a stereoscopic depth determination, said stereoscopic depth determination determining a depth to said surface.

25. The apparatus of claim 24, wherein the first bandlimited illumination pattern (900) has a maximum baseband component that occupies less than 90 percent of the Nyquist bandwidth of the first band limited illumination pattern when projected onto said surface.

26. The apparatus of claim 25, wherein the digital image is a digital signal in the form of pixel values representing the first image, said pixel values corresponding to one or more discrete points in time and being quantized to discrete levels.

27. The apparatus of claim 24, wherein the first bandlimited illumination pattern is a first grayscale image pattern generated by low pass filtering the digital signal representing the first illumination pattern.

28. The apparatus of claim 24, wherein a baseband signal component of the band limited illumination pattern has a maximum frequency, Fm, of X Hz;
wherein each of the first and second cameras has a sampling frequency exceeding at least twice the maximum frequency of X Hz; and
where X is a non-zero positive number.
